(19) United States
(12) Patent Application Publication
(10) Pub. No.: US 2001/0009352 A1
(43) Pub. Date: Jul. 26, 2001

(54) Reflective electro-optic fiber-based displays

(76) Inventor: Chad Byron Moore, Corning, NY (US)

Correspondence Address: BROWN PINNISI & MICHAELS, 400 M & T BANK BUILDING, 118 NORTH TIOGA ST, ITHACA, NY, 14850

(21) Appl. No.: 09/797,113

(22) Filed: Mar. 1, 2001

Related U.S. Application Data
(63) Continuation-in-part of application No. 09/621,193, filed on Jul. 21, 2000.
Application No. 09/621,193 is a continuation-in-part of application No. 09/517,759, filed on Mar. 2, 2000.
Application No. 09/517,759 is a continuation-in-part of application No. 09/299,372, filed on Apr. 26, 1999.

(51) Int. Cl. H01J 17/49

(52) U.S. Cl. 313/582

(57) ABSTRACT

A reflective display is formed using two orthogonal fiber arrays and an electro-optic material. The bottom fibers contain plasma channels, used to address the electro-optic material. Wire electrodes built into the fibers address both the plasma and the electro-optic material. The fibers are composed of glass, plastic or a combination of glass and plastic. Color is imparted into the display using colored fibers, adding a color coating to the surface of the fibers, or adding the color to the electro-optic material. The electro-optic material consists of a liquid crystal material, electrophoretic material, bichromal sphere material, electrochromic material, or any electro-optic material that can serve to create a reflective display. Another possible reflective displays is formed using an array of hollow tubes filled with an electrophoretic material sandwiched between two plates. The hollow tubes have either barrier walls or an electrostatic barrier, which restrict the flow of electrophoretic particles within the hollow tubes. The flow of electrophoretic particles over these barriers is controlled using electric fields, which makes it possible to matrix address the electrophoretic displays. Wire electrodes built into the hollow tubes and electrodes on the two plates are used to address the display. Reflectivity within the display is accomplished by using a reflective material to fabricate the tubes, coating the tubes with a reflective material or coating one of the two plates with a reflective material. The display can also function in a transmissive mode by applying an illuminating back to the display.

### REFERENCE TO RELATED APPLICATIONS

This is a continuation-in-part of co-pending U.S. patent application Ser. No. 09/621,193, filed Jul. 21, 2000, entitled REFLECTIVE ELECTRO-OPTIC FIBER-BASED DISPLAYS WITH BARRIERS which is a continuation-in-part of co-pending U.S. patent application Ser. No. 09/517,759, filed Mar. 2, 2000, entitled REFLECTIVE ELECTRO-OPTIC FIBER-BASED DISPLAYS, which is a continuation-in-part of co-pending U.S. patent application Ser. No. 09/299,372, filed Apr. 26, 1999, entitled FIBER-BASED PLASMA ADDRESSED LIQUID CRYSTAL DISPLAY. The aforementioned applications are hereby incorporated herein by reference.

### FIELD OF THE INVENTION

The invention pertains to the field of reflective displays and methods of manufacture. More particularly, the invention pertains to addressing electrophoretic, electrochromic, and bi-chromal sphere displays and fabricating such displays using fibers. The invention also pertains to electrophoretic displays containing barrier walls and barrier electrodes, and fabricating such displays using fibers and/or hollow tubes.

### BACKGROUND OF THE INVENTION

There are several different methods of producing a reflective display. The most well known and widely used method is to use liquid crystal molecules as the electro-optic material. In the liquid crystal family, a vast range of molecules could potentially be used to create reflective displays. Some of these liquid crystal molecules include, twisted nematic, cholesteric-nematic, dichroic dye (or guest-host), dynamic scattering mode, and polymer dispersed to name a few. Most of these liquid crystal molecules require other films, such as, alignment layers, polarizers, and reflective films.

Another type of reflective display composing an electro-optic material is an electrophoretic display. Early work such as that described in U.S. Pat. No. 3,767,392, “Electrophoretic Light Image Reproduction Process”, used a suspension of small charged particles in a liquid solution. The suspension is sandwiched between to glass plates with electrodes on the glass plates. If the particle have the same density as the liquid solution then they will not be effected by gravity, therefore the only way move the particles is using an electric field. By applying a potential to the electrodes, the charged particles are forced to move in the suspension to one of the contacts. The opposite charge moves the particles to the other contact. Once the particles are moved to one of the contact they reside at that point until they are moved by another electric field, therefore the particles are bistable. The electrophoretic suspension is designed such that the particles are a different color than the liquid solution. Therefore, moving the particles from one surface to the other will change the color of the display. One potential problem of this display is the agglomeration of the small charged particles when the display is erased, i.e., as the pixel is erased the particles are removed from the contact in groups rather than individually. The invention of microencapsulating the electrophoretic suspension in small spheres solves this problem, U.S. Pat. No. 5,961,804, “Microencapsulated Electrophoretic Display.” FIG. 1 shows the typical operation of a microencapsulated electrophoretic display. In this display the particles are positively charge and are attracted to the negative terminal of the display. The charged particles are white and the liquid solution they are suspended in is dark, therefore contrast in the display is optionally achieved by selectively moving some of the particles form one contact to the other. In this type of display, the electro-optic material is the electrophoretic material and any casing used to contain the electrophoretic material.

A similar type of electro-optic display, a twisting ball display or Gyricon display, was invented by N. Sheridon at Xerox, U.S. Pat. No. 4,126,854, “Twisting Ball Display.” It was initially called a twisting ball display because it is composed of small spheres, one side coated black, the other white, sandwiched between to electroded glass plates, as shown in FIG. 2. Upon applying an electric field the spheres with a positive charged white half and relative negative charged black half are optionally addressed (rotated). Once the particles are rotated they stay in that position until an opposite field is applied. This bistable operation requires no electrical power to maintain an image. A follow on patent, U.S. No. 5,739,801, disclosed a multithreshold addressable twisting ball display. In this type of display, the electro-optic material is the bichromal spheres and any medium they may reside in to lower their friction in order to rotate.

Another major electro-optic display is that produced using an electrochromic material. An electrochromic display, similar to that in U.S. Pat. No. 3,521,941, “Electro-optical Device Having Variable Optical Density”, is a battery which has one of the electrodes serving a display function. An electrochemical display stores electrical energy by changing it into chemical energy via an electrochemical reaction at both electrodes. In this reaction, electrochemically active material is plated-out on one of the contacts changing it from transparent to absorbing. FIG. 3 shows the typical reaction of an electrochromic display, where an electrochemical reaction from the applied voltage causes material to plate out on the negative terminal of the display. In this type of display, the electro-optic material is the electrochromic material, which is sandwiched between the electroded plates.

Most of the electro-optic displays have problems with addressing the display. Since most of the electro-optic materials do not have a voltage threshold, displays fabricated with the materials have to be individually addressed. Some of the liquid crystal materials use an active transistor back plane to address the displays, but these type of displays are presently limited in size due to the complicated manufacturing process. Transmissive displays using liquid crystal materials and a plasma addressed back plane have been demonstrated, U.S. Pat. No. 4,896,149, as shown in FIG. 4, however, a reflective display using such a technique has not be disclosed. In addition, displays fabricated using the plasma addressed back plane shown in FIG. 4 are also limited in size due to availability of the thin microsheet 33. One potential solution for producing large size displays is to use fibers to create the plasma cells as shown in FIG. 5. Using fibers to create a plasma cell was first disclosed in U.S. Pat. No. 3,964,050, and using fibers to create the plasma cell in a transmissive plasma addressed liquid crystal display was disclosed in U.S. Pat. No. 5,984,747.

Another method of producing a reflective display uses an electrophoretic switching material. Early work such as that described in U.S. Pat. No. 3,767,392, “Electrophoretic Light Image Reproduction Process”, used a suspension of small charged particles in a liquid solution (electrophoretic suspension) for displaying a light image. The suspension is sandwiched between two glass plates with electrodes on the glass plates. If the particles have the same density as the liquid solution then they will not be effected by gravity, therefore the only way to move the particles is by using an electric field. By applying a potential to the electrodes, the charged particles are forced to move in the suspension to one of the contacts. The opposite charge moves the particles to the other contact. Once the particles are moved to one of the contacts, they reside at that point until they are moved by another electric field, therefore the particles are bistable. The electrophoretic suspension is designed such that the particles are a different color than the liquid solution. Therefore, moving the particles from one surface to the other will change the color of the display.

As mentioned above it is very difficult to address most electrophoretic displays because electrophoretic materials do not have a voltage threshold. Therefore, displays fabricated with the electrophoretic materials have to be individually addressed at each pixel by using active devices such as a transistor array or a plasma. Active devices are complicated and expensive to fabricate and are usually limited in size. Therefore, an addressing scheme where the display can be passively addressed is desired. One such addressing scheme was introduced by Philips in U.S. Pat. No. 4,203,106 where they added a third control electrode to create a voltage threshold to manage the migration of particles. This third electrode is patterned with holes and is placed over and orthogonal to the attraction electrode. Controlling the voltage on the control electrode causes the particles to migrate into the holes in the control electrode, in turn, changing the color of the display.

Another passively addressed display was invented at Copytele, U.S. Pat. No. 5,345,251. This display is constructed using interleaved electrodes and an orthogonal electrode. The movement of the particles is in the plane between the interleaved electrode and is controlled by the orthogonal electrode. The addressing electrode controls the movement of the particles in all of these passively addressed displays. Since the particles do not have a voltage threshold, it makes it very difficult to matrix address the display. In order to achieve passive matrix addressing, a barrier must be added to the cell between the two driving electrodes.

A display that uses a barrier between drive electrodes was disclosed by E. Kishi, et al., “Development of In-Plane EPD”, SID 00 Digest, pp. 24-27. Two types of barriers were disclosed: a physical barrier 48, shown in FIG. 6, and an electrical barrier 44, shown in FIG. 7. Both displays are constructed by building up the structure on a top 30T and a bottom 30B substrate. A separator 45 is used to create the cell that houses the electrophoretic material 37. The drive electrodes 43 and 42 are electrically isolated from the cell and each other using dielectric layers 46 and 47. The operation of these displays is achieved by placing voltages on both driving electrodes 43 and 42 and controlling the flow of particles over the barriers using the control electrode 41.

Assuming the particles 37 are positively charged, then the display is in a holding state when a large positive voltage is applied to the control electrode 41, a small positive voltage is applied to the 1^{st} driving electrode 43, and a negative voltage is applied to the 2^{nd} driving electrode 42. In the case where the barrier is created by an electric field (FIG. 6), a positive voltage is applied to the barrier electrode 44. To move the particles 37 from the 1^{st} driving electrode 43 to the 2^{nd} driving electrode 42, the positive voltage on the control electrode 41 is reduced. In this case, the particles 37, which are repelled from the 1^{st} driving electrode 43, are allowed to flow over the barrier to the 2^{nd} driving electrode 42.

This passive method of addressing by adding barriers helps in addressing the pixel, but has problems addressing more than one row in a display. In addition, the display will have a high manufacturing cost because of the multiple steps needed to create the structure and pattern the electrodes in the display. The display will also be limited in size since the structure is built-up on a substrate. The following invention solves the manufacturing and addressing issues and is cost effective in a large panel display.

### SUMMARY OF THE INVENTION

The invention includes the use of fibers with wire electrodes to construct reflective fiber-based displays, where reflectivity is formed by modulating an electro-optic material within the display. A plasma channel is optionally built into the display to address the electro-optic material. The plasma channel is optionally totally contained within the fibers and addressed using wire electrodes. The wire electrodes are contained within the fiber or on the surface of the fiber. The fibers are optionally colored to impart color to the display, or are optionally black to serve as an absorbing layer to enhance the contrast of the display, or white to enhance the reflectivity of the display. The electro-optic material consists of a liquid crystal material, electrophoretic material, bichromal sphere material, electrochromic material, or any electro-optic material that can serve to create a reflective display. In addition, colored pigment is optionally added to the electro-optic material to impart color to the display. The fibers are optionally composed of glass, glass ceramic, plastic/polymer, metal, or a combination of the above.

The invention also includes the use of hollow tubes filled with an electrophoretic material sandwiched between two plates to form a reflective display. The hollow tubes have either barrier walls or an electrostatic barrier, which restricts the flow of electrophoretic particles within the hollow tubes. The flow of electrophoretic particles over these barriers is controlled using electric fields, which makes it possible to matrix address the electrophoretic displays. Wire electrodes built into the hollow tubes and electrodes on the two plates are used to create the electric field and address the display. The electrodes on the plates can be replaced with wire electrodes or wire electrodes contained within a fiber. The plates are preferably composed of glass, glass-ceramic, polymer/plastic or metal, while the hollow tubes are preferably composed of glass, polymer/plastic or a combination of glass and polymer/plastic. In addition, color is optionally imparted into the display using colored tubes, adding a color coating to the surface of the tubes, or adding the color to the electrophoretic material. Reflectivity within the display is accomplished by using a reflective material to fabricate the tubes, coating the tubes with a reflective material or coating one of the two plates with a reflective material. The display can also function in a transmissive mode by applying an illuminating back to the display.

### BRIEF DESCRIPTION OF THE DRAWING

FIG. 1 schematically shows a cross-section and addressing of an electrophoretic display, in accordance with the prior art.

FIG. 2 schematically shows a cross-section and addressing of a bichromal sphere display in accordance with the prior art.

FIG. 3 schematically shows a cross-section and addressing of an electrochromic display in accordance with the prior art.

FIG. 4 illustrates a traditional PALC display in accordance with the prior art.

FIG. 5 illustrates a fiber-based PALC display.

FIG. 6 schematically shows a structural barrier type in plane switching electrophoretic display, in accordance with the prior art.

FIG. 7 schematically shows an electrical barrier type in plane switching electrophoretic display, in accordance with the prior art.

FIG. 8 schematically shows a cross-section of a top fiber structure containing ribs to form the structure that supports the electro-optic material.

FIG. 9 schematically shows a cross-section of a top fiber structure with a built-in black matrix.

FIG. 10A schematically shows a cross-section of a top fiber structure with a contoured surface around the wire electrodes to control the electric field through the electro-optic material.

FIG. 10B schematically shows a cross-section of a top fiber structure with a contoured surface around the wire electrodes to control the electric field through the electro-optic material.

FIG. 11A schematically shows a cross-section of a top fiber structure with a dissolvable material used to expose the wire electrodes.

FIG. 11B schematically shows a cross-section of a top fiber structure in FIG. 11A with the dissolvable material removed, thus exposing the wire electrodes.

FIG. 12 schematically shows a cross-section of a top fiber structure with a conductive surface layer.

FIG. 13 illustrates a hollow tube with a conductive region through part of one wall of the hollow tube and conductive region through glass encased layer.

FIG. 14 schematically shows a plasma-addressed electrophoretic display with a conductive region through the hollow tubes.

FIG. 15 schematically shows an array of top fiber structures composed of different colored fibers and different colored electro-optic material, both of which add color to the display.

FIG. 16 schematically shows an array of fibers containing wire electrodes and ribs that create the structure to support the electro-optic material and a glass plate with transparent electrodes to form the opposite electrode surface.

FIG. 17 schematically shows two orthogonal fiber arrays with wire electrodes, where the structure of the electro-optic display is formed using one of the fiber arrays.

FIG. 18 schematically shows two orthogonal fiber arrays with wire electrodes, where the structure of the electro-optic display is formed using both fiber arrays.

FIG. 19 schematically shows a bowed top fiber that creates a small gap for the flow of the reflection reducing fluid.

FIG. 20 schematically shows legs on a top fiber to create a small gap for the flow of the reflection reducing fluid.

FIG. 21 schematically shows an array of fibers containing plasma channels with wire electrodes to address the plasma channels and ribs to form the structure in the electro-optic display, and a glass plate with transparent electrodes to form the opposite electrode surface.

FIG. 22 schematically shows an array of fibers containing plasma channels with wire electrodes to address the plasma channels and ribs to form the structure in the electro-optic display, and a second orthogonal fiber array with wire electrodes to form the opposite electrode surface.

FIG. 23 schematically shows an array of fibers containing plasma channels with wire electrodes to address the plasma channels, a second orthogonal fiber array with wire electrodes to address the display, and a glass substrate with a transparent electrode coating to modulate the electro-optic material.

FIG. 24 schematically shows an array of fibers containing plasma channels with wire electrodes to address the plasma channels and a second orthogonal fiber array with two sets of wire electrodes; one to address the display and one to modulate the electro-optic material.

FIG. 25A schematically shows a plasma tube with a charge storing medium located on the inside surface of the plasma region.

FIG. 25B schematically shows a plasma tube with a charge storing medium located in the thin membrane at the top plasma tube.

FIG. 25C schematically shows a plasma tube with a charge medium region located on the topside of the plasma tube.

FIG. 26 schematically illustrates a reflective display where the electro-optic material is contained within a fiber.

FIG. 27 schematically illustrates a reflective display where the plasma to address the electro-optic material is addressed at every pixel location.

FIG. 28 schematically illustrates a total-fiber reflective display where the electro-optic material is contained within a fiber and the display is plasma addressed.

FIG. 29 schematically illustrates a reflective display where the plasma is confined and addressed at each individual pixel.

FIG. 30A schematically shows a cross-section of a bottom fiber structure with a dissolvable material used to hold the tolerance in the fiber during the draw process.

FIG. 30B schematically shows a cross-section of a top fiber structure in FIG. 30A with the dissolvable material removed.

FIG. 31A schematically shows a plasma tube with the electrodes at the ends of the tubes.

FIG. 31B schematically shows a plasma tube with built in spacers for the electro-optic material and electrodes at the ends of the tubes.

FIG. 32 schematically illustrates a transflective display.

FIG. 33A schematically shows the top fiber in FIG. 32 with absorbing sides and a reflective base.

FIG. 33B schematically shows the top fiber in 33A with the particles in the electrophoretic material pulled to one of the side contacts.

FIG. 33C schematically shows the top fiber in 33A with the particles in the electrophoretic material pulled to the bottom of the channel.

FIG. 33D schematically shows the top fiber in 33A with bichromal spheres aligned using an in plane voltage.

FIG. 33E schematically shows the top fiber in 33A with bichromal spheres aligned using a voltage normal to the plane of the display.

FIG. 34A schematically shows a bichromal sphere.

FIG. 34B schematically shows a bichromal sphere floating in a self-contained sack.

FIG. 35A schematically shows a dipolar particle that can be used as a light valve.

FIG. 35B schematically shows a dipolar particle that can be used as a light valve floating in a self-contained sack.

FIG. 36 schematically shows an electro-optic film created using bichromal spheres floating in a self-contained sacks.

FIG. 37 illustrates a cost effective method of applying the high voltages to the display.

FIG. 38 schematically shows a structural barrier type in plane switching electrophoretic display using hollow tubes containing barrier walls and wire drive electrodes.

FIG. 39 illustrates voltage waveforms to address a pixel in the display shown in FIG. 38.

FIG. 40A schematically shows a cross-sectional view of a single pixel of the in plane switching electrophoretic display using hollow tubes containing barrier walls and wire drive electrodes in the unwritten hold state.

FIG. 40B schematically shows a cross-sectional view of a single pixel of the in plane switching electrophoretic display using hollow tubes containing barrier walls and wire drive electrodes during a writing state.

FIG. 40C schematically shows a cross-sectional view of a single pixel of the in plane switching electrophoretic display using hollow tubes containing barrier walls and wire drive electrodes in the written hold state.

FIG. 41 schematically shows a cross-sectional view of a hollow tube containing a wire drive electrode and a wire barrier electrode.

FIG. 42 schematically shows a cross-sectional view of a hollow tube containing a wire drive electrode, a barrier wall and a wire barrier electrode attached to the top of the barrier wall.

FIG. 43 schematically shows a cross-sectional view of a hollow tube containing a wire drive electrode, a wire barrier electrode and a wire control electrode at the top of the hollow tube directly above the wire barrier electrode.

FIG. 44A schematically shows a cross-sectional view of a hollow tube containing a wire drive electrode, a barrier wall and a wire control electrode at the top of the hollow tube directly above the barrier wall.

FIG. 44B schematically shows a cross-sectional view of a hollow tube containing a wire drive electrode, a barrier wall and a wire control electrode in the top corner of the hollow tube.

FIG. 45A schematically shows a cross-sectional view of a hollow tube composed of absorbing sidewalls to serve as a black matrix.

FIG. 45B schematically shows a cross-sectional view of a hollow tube coated with an absorbing film on the sidewalls to serve as a black matrix.

FIG. 45C schematically shows a cross-sectional view of a skewed hollow tube coated with an absorbing film on the side-walls to block all unwanted light through the display.

FIG. 46A schematically shows a cross-sectional view of a hollow tube composed of a colored material to add color to the display.

FIG. 46B schematically shows a cross-sectional view of a hollow tube containing colored electrophoretic particles to add color to the display.

FIG. 46C schematically shows a cross-sectional view of a hollow tube composed of a colored material and containing colored electrophoretic particles to add color to the display.

FIG. 47A schematically shows a cross-sectional view of a hollow tube composed of a reflective material to add reflectivity to the display.

FIG. 47B schematically shows a cross-sectional view of a hollow tube coated with a reflective material to add reflectivity to the display.

FIG. 48A schematically shows a cross-sectional view of the top plate with transparent address electrodes, shown in FIG. 38.

FIG. 48B schematically shows a cross-sectional view of the address electrodes composed of an array of wire electrodes.

FIG. 48C schematically shows a cross-sectional view of an array of fibers containing one wire address electrode per fiber to replace the top plate.

FIG. 48D schematically shows a cross-sectional view of an array of fibers containing three-wire address electrode per fiber to replace the top plate.

FIG. 49A illustrates the change in cross-sectional shape of the preform/fiber in the root during the draw process.

FIG. 49B schematically shows a cross-sectional view of the top of the root shown in FIG. 49A.

FIG. 49C schematically shows a cross-sectional view of the bottom of the root shown in FIG. 49A.

FIG. 50A illustrates how the angle of the barrier wall changes after the draw process.

FIG. 50B illustrates how the angle of the barrier wall changes after the draw process if it is positioned against the drive electrode.

FIG. 51 schematically shows a cross-sectional view of a hollow tube with the wire drive electrode and barrier wall in the top corner of the hollow tube.

FIG. 52 schematically shows a cross-sectional view of a hollow tube with an additional wire drive electrode.

FIG. 53 schematically shows a cross-sectional view of a hollow tube with three wire drive electrodes in the bottom section of the tube.

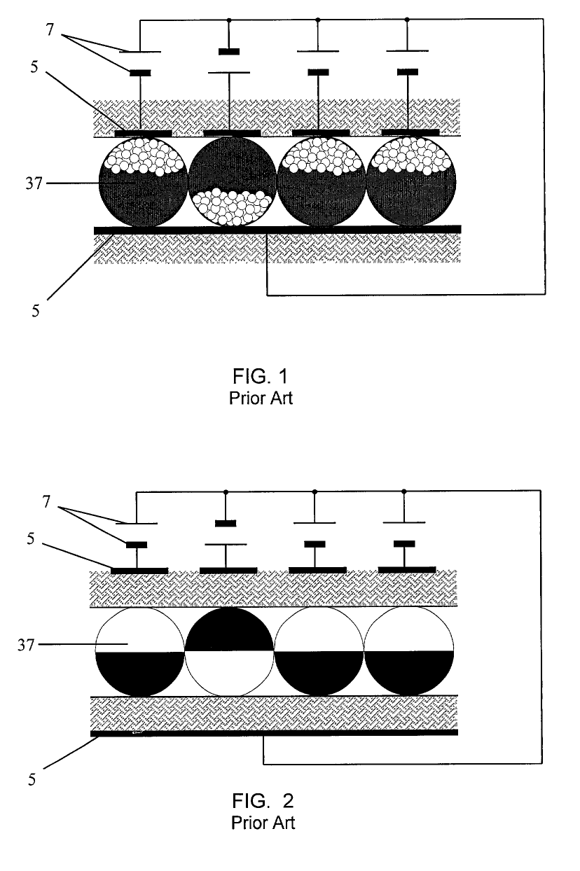

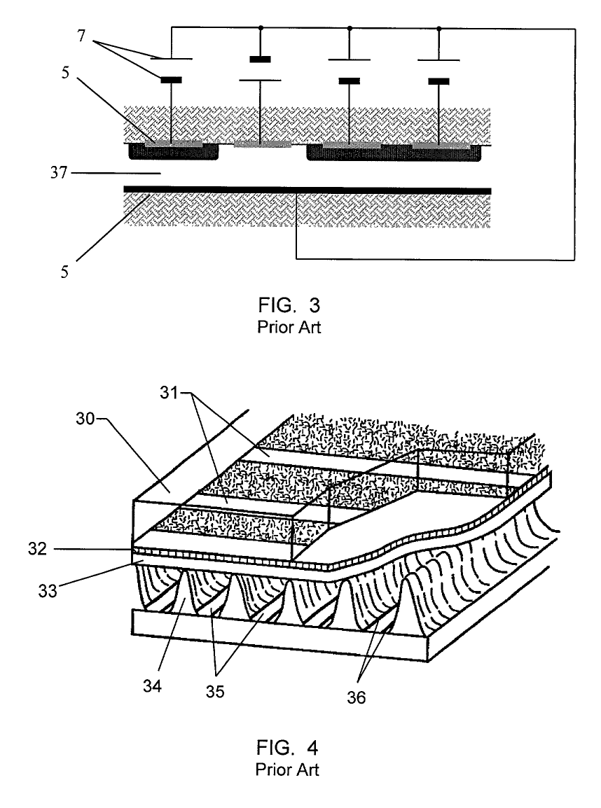

### DESCRIPTION OF THE PREFERRED EMBODIMENT

The invention includes the use of fibers with wire electrodes to construct reflective fiber-based displays, where reflectivity is formed by modulating an electro-optic material within the display. The wire electrodes are contained within the fiber or on the surface of the fiber. The fibers are optionally colored to impart color to the display, or are optionally black to serve as an absorbing layer to enhance the contrast of the display, or white to enhance the reflectivity of the display. The electro-optic material consists of a liquid crystal material, electrophoretic material, bichromal sphere material, electrochromic material, or any electro-optic material that can serve to create a reflective display. Most of these electro-optic materials are bistable in their operation. In addition, colored pigment is optionally added to the electro-optic material to impart color to the display. The fibers are optionally composed of glass, glass ceramic, plastic/polymer, metal, or a combination of the above. The term fiber is used to explain any long linear structure either in a solid or tubular form usually supporting a complex, non-circular cross-section.

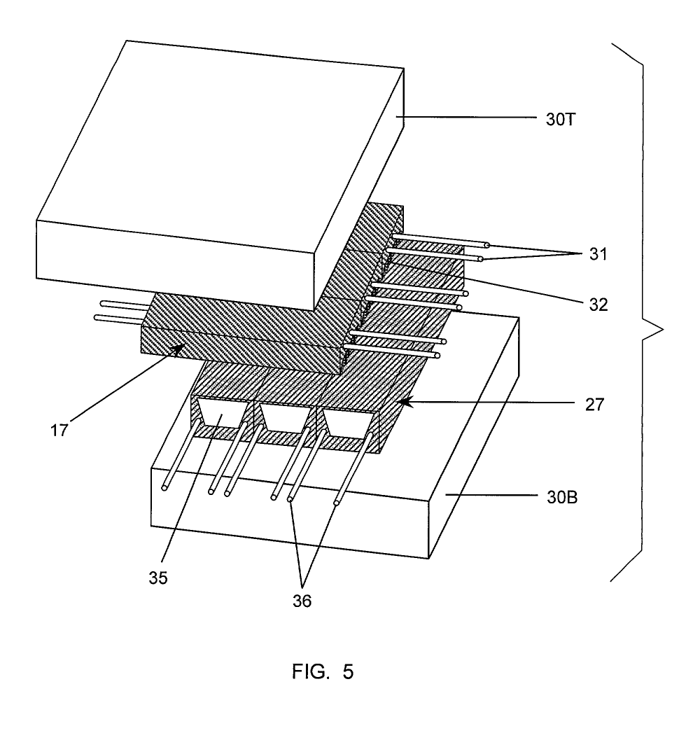

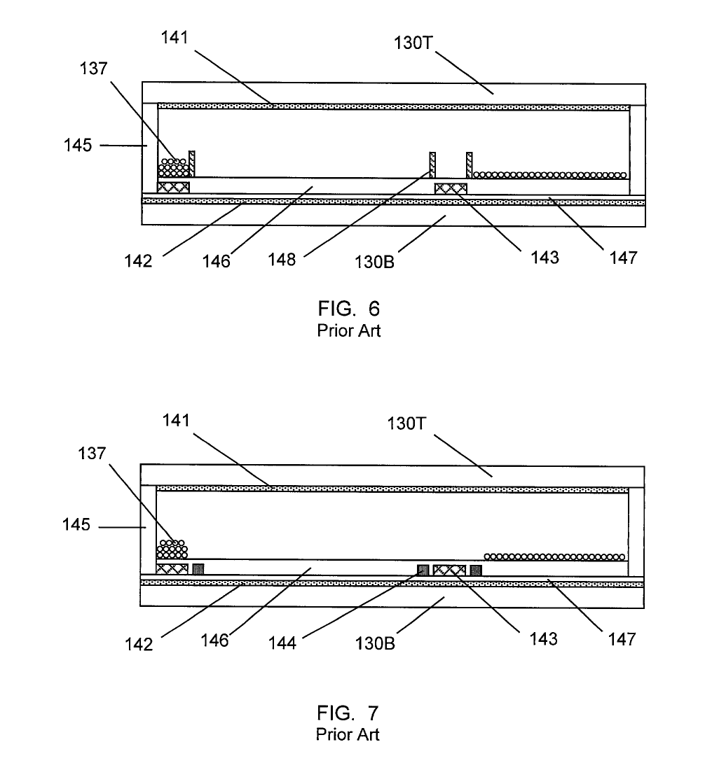

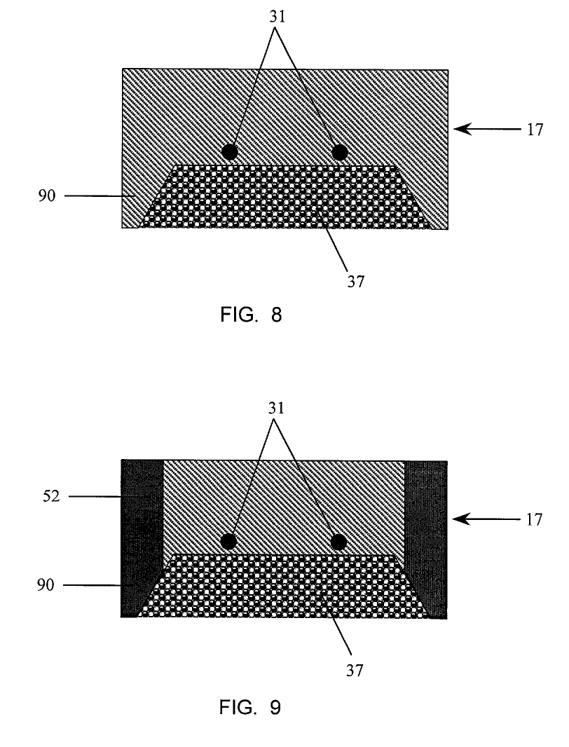

FIG. 5 shows a schematic of a plasma addressed liquid crystal (PALC) display using both top 17 and bottom 27 fibers to create the structure in the display, as disclosed in U.S. patent application Ser. No. 09/299,372. Modifying the top fiber 17 in this fiber-based PALC display, such as shown in FIG. 8, would create a reflective display. To create a reflective display, the traditional liquid crystal, alignment layers and polarizers are replaced with an electro-optic material 37. Legs or ribs 90 are optionally formed on the ends of the top fiber 17 to create a channel to support the electro-optic material 37. Upon operation, a plasma is ignited in the plasma channel 35 using the plasma address electrodes 36. The plasma creates many electrons and ions in the plasma channel 35. During or shortly after the plasma glow period, a voltage is applied to the address electrodes 31 in the top fiber 17. This voltage, if positive relative to the plasma address electrodes 36, will plate a negative charge out on the upper inside surface of the plasma channels 35, directly below the electro-optic material 37. After the plasma is extinguished, the free carriers diminish from the plasma gas, leaving the negative charge or electrons on the upper surface of the channel 35. Upon removing the applied voltage from the address electrodes 31, an electric field is set up between the deposited charge and the address electrodes 31. This electric field will slowly modulate the electro-optic material. Note that the plasma addressing time is much faster than the response time of the electro-optic material. Because the charge on the inner surface of the plasma cell 35 is not stable, the plasma may have to be addressed more than once per image frame in order to fully address the electro-optic material.

Gray scale images are optionally created in the display by controlling the address voltage or by dividing the addressing time into sections or bits, similar to the addressing scheme of a plasma display. The time the charge is plated-out in the plasma channel 35 is optionally broken down into 8-bit increasing time domains, or 256 levels of gray scale. Another method of creating a gray scale image is to divide the address voltage between the address electrodes 31. Applying the full on address voltage to one of the address electrodes will cause the electro-optic material to switch below that wire electrode and not the other. Thus, two bits of gray scale are optionally created if there are two electrodes and the voltage is full on or full off. If the voltage is divided between the two electrodes and its magnitude is also controlled, then the total number of gray scale levels equals the voltage bits of gray scale times the number of electrodes. In addition, using separate wires to address a bichromal sphere twisting ball display would allow the ball to be rotated to specific angles. Rotating the ball to a specific angle not only controls the gray scale, but also controls the direction of the reflected light. Controlling the direction of reflected light is extremely useful to maximize the usage of a point light source, such as, for example, the sun.

FIG. 9 is a schematic cross-section of a top fiber 17 similar to that shown in FIG. 8, except the sides of the fiber 52 are black or absorbing to create a black matrix function. The absorbing sides 52 are optionally included in the top fiber 17, or are optionally coated on the surface of the fiber 17. The fibers are optionally composed of either an inorganic material, such as, for example, glass, or an organic material, such as, for example, an organic polymer. The black matrix 52 helps to define the pixels and create a sharper image.

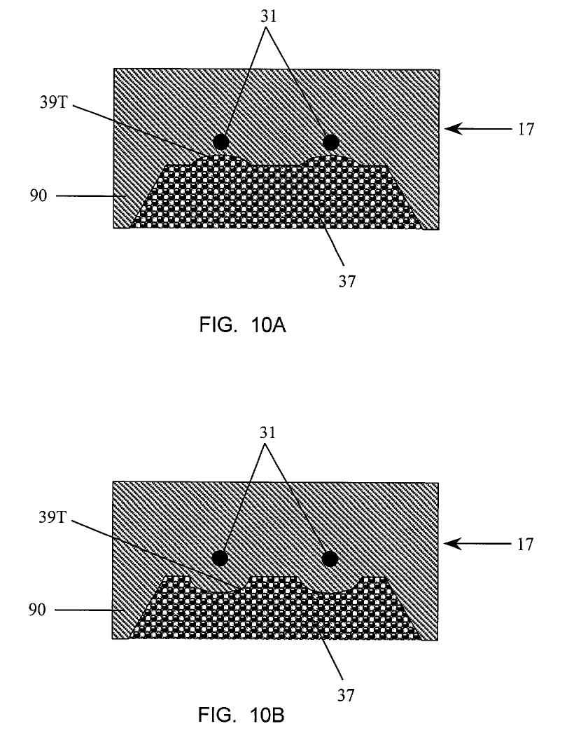

FIGS. 10A and 10B show a method of controlling the electric field around the address electrodes 31. Contouring the surface 39T of the top fiber 17 allows for tight control of the shape of the electric field lines through the electro-optic material 37. The voltage drop (electric field) from the address electrodes 31 to the electrons in the plasma channel is divided between the glass or plastic in the top fiber 17, between the address electrodes 31 and the surface of the fiber 39T, the electro-optic material 37, and the thin glass membrane at the top of the plasma channel 35. In order to obtain close to vertical electric field lines in the electro-optic material 37, the surface 39T of the top fiber is modified, depending on the dielectric constant of the top fiber 17 material and the electro-optic material 37. FIG. 10A depicts a concave surface contour 39T, which is needed to produce vertical electric field lines if the electro-optic material has the higher dielectric constant. FIG. 10B depicts a convex surface contour 39T, which is needed to produce vertical electric field lines if the top fiber 17 material has the higher dielectric constant. Note that although the figures depict two address electrodes 31, any number of address electrodes can be used per pixel.

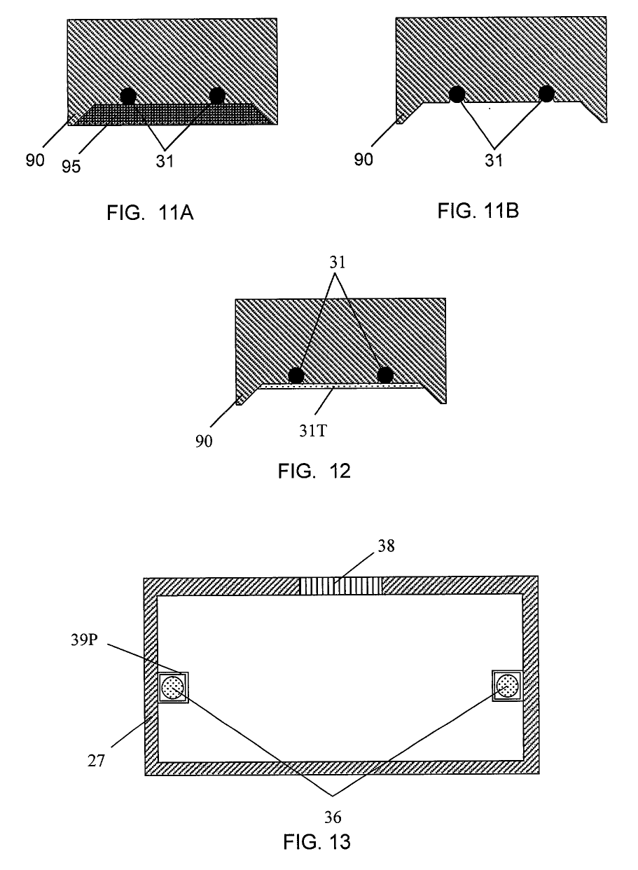

FIG. 11 shows a method of exposing the electrodes to the surface, using a lost glass process similar to that disclosed in patent application Ser. No. 09/299,394, “Lost Glass Process Used in Making Fiber-Based Displays”, the disclosure of which is hereby incorporated herein by reference. A dissolvable glass 95 is optionally co-extruded with the base glass 27, to form a preform for fiber draw. The wire electrodes 31 are optionally drawn into the fiber, shown in FIG. 11A, and the dissolvable glass 95 is optionally subsequently removed with a liquid solution, as shown in FIG. 11B. Typical liquid solutions to dissolve the glass include, for example, vinegar and lemon juice. A dissolvable glass 95 is optionally used to hold the wire electrode in a particular location during the draw process. When the dissolvable glass 95 is removed, the wires become exposed to the environment outside the fiber. If the fiber is formed using a polymer, then two different polymers are needed, where one polymer is optionally removed without effecting the other. This removal process is optionally by wet etching, dry etching or thermal treatment. Creating a conductive path between the electrodes and the electro-optic material is necessary for the electrochromic displays and most electrophoretic displays.

FIG. 12 shows a method of creating a conductive surface by applying a conductive material 31T to the surface of the fiber and in contact to the conductive wire electrodes 31. This conductive material 3IT must be transparent. The conductive layer is optionally added to the preform during the draw or extrusion process, or added to the fiber after it has been drawn.

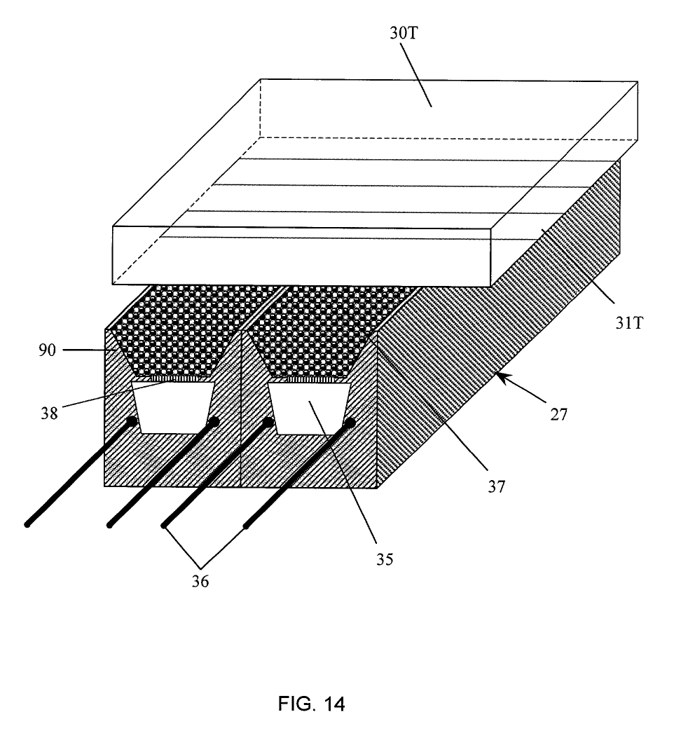

FIG. 13 illustrates a cross-section of a hollow tube 27 with a conductive region 38 extending through the wall of the hollow tube 27. This conductive region 38 electrically connects the inside of the tube to the outside of the tube. Therefore, if the hollow tube 27 was backfilled with a plasma gas and a plasma was ignited between the plasma electrodes 36 then charge form the plasma could flow through the wall 38 to the outside surface. In the case of the plasma-addressed electro-optic display, shown in FIG. 14, current would flow from the plasma 35 through the wall 38 of the hollow tube and through the electro-optic material 37 to the top address electrode 31T. Assuming the electro-optic material 37 is an electrophoretic material composed of TiO₂ particles, then the charge flowing through the system will charge the TiO₂ particles and allow them to move within the electrophoretic cell. Conductive regions could also be formed in the structure 39P used to house the plasma electrodes 36 during the draw process. Creating a conductive region 39P around the plasma electrodes 36 will electrically connect the plasma electrodes 36 to the plasma region. This will change the plasma firing from AC to DC and help drain the charge from the plasma cell after plasma ignition.

A conductive region can be formed using several different methods. One method is to place small conductive particles into the preform before fiber draw. The small conductive particles can be mixed into the base glass and added to the preform. Therefore, during the fiber draw process the small conductive particles will flow with the glass and form a fiber/hollow tube with a conductive wall. The glass composition mixed into the small particles may need to be modified to be expansion matched to the base glass that forms the preform/fiber. The small particles can be composed of metal or an alloy, such as W, Ti, Ta, Mo, Nb, Cr, Fe, Co, Ni, Cu, Pt, Au, Zr, etc., and can contain a multitude of shapes, such as, spherical, elliptical, or even whiskers. The particles would also be composed of a semiconductor material such as SiC, TiO₂, CuS, etc. and can also take on any shape, such as, spherical, elliptical, whiskers, etc. These small particles can be mixed and sintered into a glass powder to be added to a preform, which is drawn to the final fiber size.

Another method of creating a conductive region 38 is to simply use conductive glass. Conductive glass is somewhat of an oxymoron, however, there are some high Cu and Pb containing glasses that have reasonable conductivity. Precipitating small conductive spheres out in the glass produces a conductive phase separated glass where conductivity is created by electron hopping from one conductive particle to the next. A glass can also be ceramed to produce small crystals that are conductive. The glass regions that are to be ceramed can be composed of a glass-ceramic. Another method is to use a ceramable glass for the entire preform and then only ceram the areas of interest. A laser can be used to induce a ceramable region, where crystals grow in the laser written areas during the post heat treating process step. Therefore, selective areas along the fiber can be ceramed to create conductive regions.

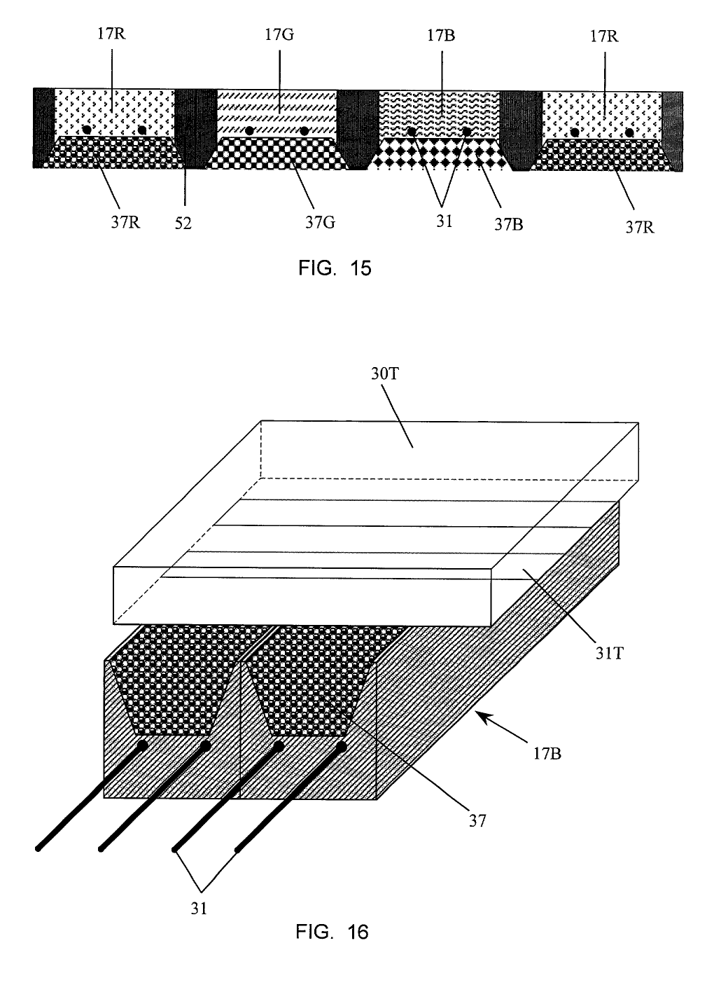

FIG. 15 shows two different methods of adding color to the displays. First, the fibers 17R, 17G, and 17B are optionally colored. The fibers 17 are optionally colored by adding a color agent to the base fiber material before forming the fibers 17. The fibers 17 are optionally colored by applying a thin colored film to the surface of the fiber. Adding a color film to the surface is similar to what is done in the liquid crystal display industry to create a color filter. Another method of adding color to the display is to add color to the electro-optic material 37R, 37G, and 37B. In the bichromal sphere display, one half of the sphere can simply be made from a colored material. In the electrophoretic material the color is optionally added to either the small charged particles or the liquid suspension solution.

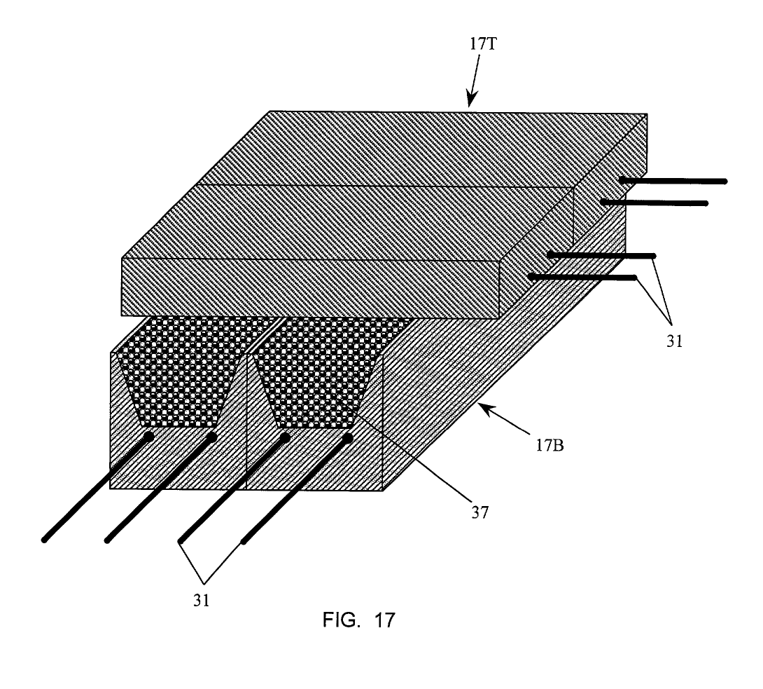

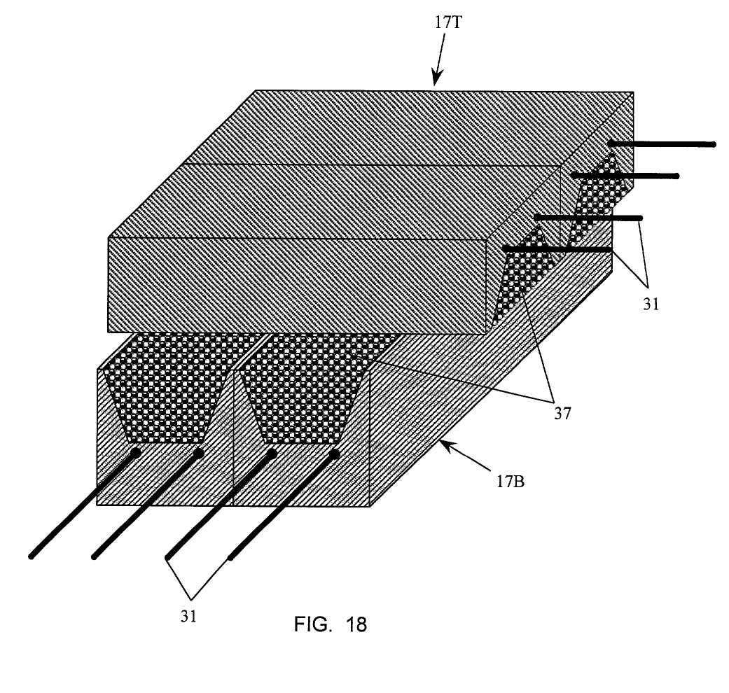

FIG. 16 shows a reflective display with an array of bottom fibers 17B that form one half of the display, and a top plate 30T forming the other half. The bottom fibers 17B have channels that support an electro-optic material 37, and wire electrodes 31 to address the electro-optic material. The top plate 30T has transparent electrodes 31T to address the electro-optic material 37. To complete the display, a substrate may be required below the bottom fibers 17B, such that the fiber array 17B is sandwiched between the two plates. The plates are optionally made of glass or plastic. The top plate is optionally replaced with an array of fibers 17T to make a total-fiber display, as shown in FIG. 17. This total-fiber display may have to be sandwiched between two plates to add rigidity to the display. Additional structure is optionally added to the top fiber 17T to form a channel to support an electro-optic material 37, as shown in FIG. 18. Identical fibers are optionally used for the top 17T and 10 bottom 17B fiber arrays. Note that the fibers are not rigid and are optionally bent around a curved surface, therefore fabricating a curved display.

One problem with using an array of fibers to create the structure of the reflective display is presented by the additional surfaces created between the top plate 30T and the fiber array 17. These additional surfaces create a reflection, which lowers the contrast ratio of the display. To reduce or eliminate these reflections, a flowable polymer material is optionally included into the structure between the top plate 30T and the fiber array 17. A polymer material, such as, for example, ethylvinyl acetate, EVA, is optionally used to remove these reflections.

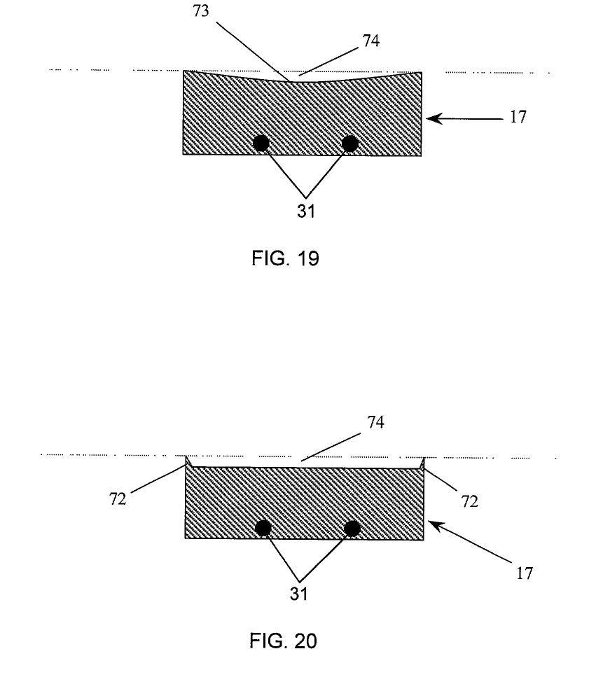

Another method of removing the reflections at the fiber/substrate interface is to use an index matching oil. Using an oil medium with the same or similar index of reflection to the fibers and substrate(s) will drastically reduce or eliminate the amount of light reflected at the interfaces. This method of adding oil to reduce the reflection would be very advantageous if a bichromal sphere twisting ball material is used as the electro-optic material. The bichromal sphere twisting ball material is traditionally made by mixing small bichromal ball (black on one side and white on the other) in a polymer to form a film. The film is then treated to create an open cell structure around the bichromal balls. Silicone oil is then added to the film to float the bichromal balls and add lubrication around them so they can rotate. To keep the bichromal balls rotating over the life of the display it would be advantageous to have the filhn housing the bichromal spheres continually soaking in oil. Structure could also be added to the fibers to assist in getting the oil to flow into the interface between the fibers and/or fibers and substrate(s). The fibers 17 could be bowed inward with respect to its cross-section to create a gap 74 between the fiber 17 and the top substrate, as shown in FIG. 19. Legs 72 could be added to the surface of the fibers 17, as shown in FIG. 20, to create small cell gaps 74 for fluid flow. An oil reservoir could also be added to the display to house a volume of oil to control the amount of oil need during the temperature cycles of the display.

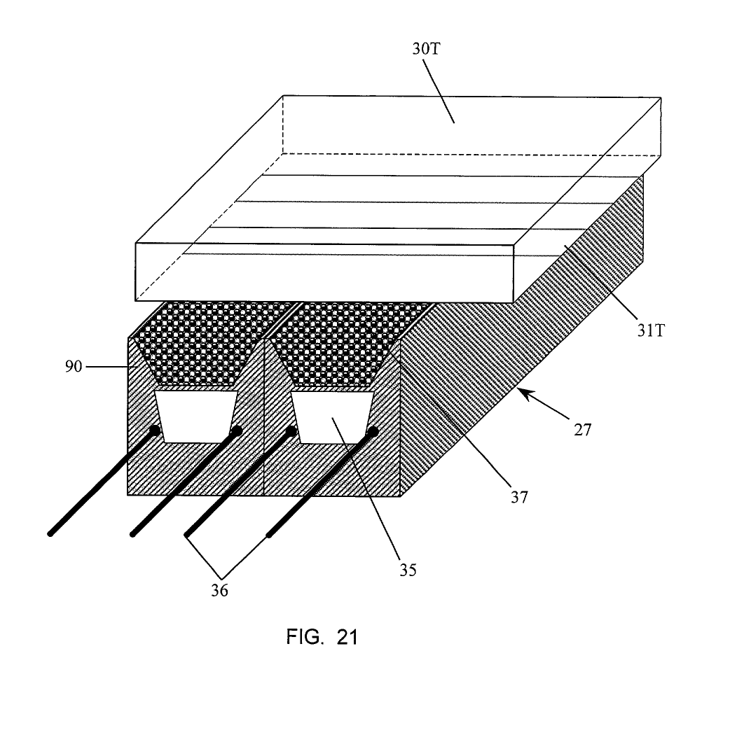

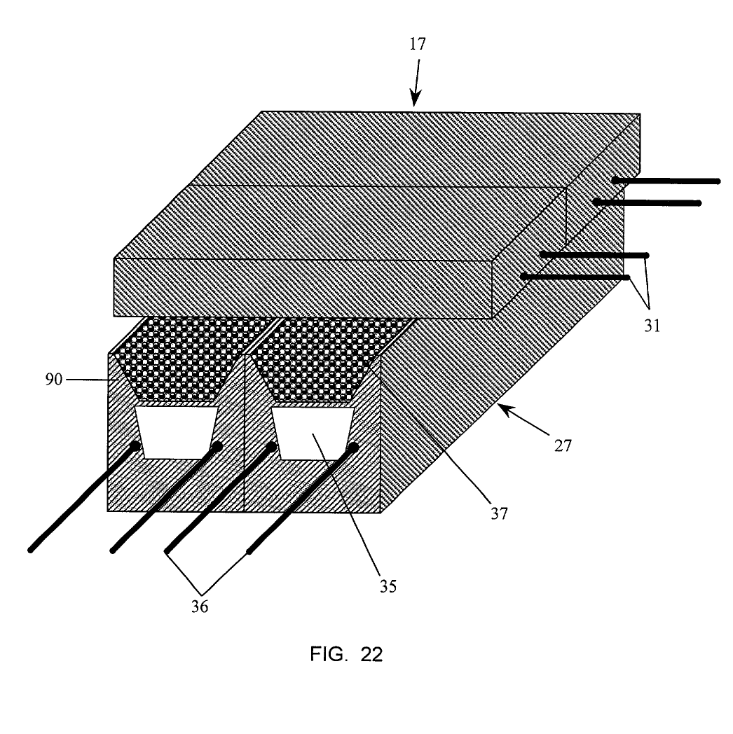

FIG. 21 shows a reflective electro-optic display similar to that shown in FIG. 5 except the spacers 90 that create a channel for the electro-optic material 37 are contained in the bottom fibers 27. This type of display is operated very similarly to the one in FIG. 5. A plasma is ignited in the plasma cell region 35 using the plasma address electrodes 36, and a voltage is applied to the transparent electrodes 31T in the top plate 30T. This applied voltage is used to store the charge on the upper inside surface of the plasma channel 35. The stored charge creates an electric field between the charge and the transparent electrodes 31T. The electric field modulates the electro-optic material 37. Replacing the top plate 30T with fibers containing wire electrodes 31, as shown in FIG. 22, creates a total-fiber plasma display. Creating a total-fiber display not only allows for the fabrication of very large displays, but also allows for fabrication of curved, 3-D, and multiple view displays, if a lens function is built into the top fiber 17, as discussed in patent application entitled “FIBER-BASED DISPLAYS CONTAINING LENSES AND METHOD OF MAKING SAME,” filed on Mar. 2, 2000, the complete disclosure of which is hereby incorporated herein by reference. A lens built into the top fiber 17 alters the refection of the light going through the fiber. The lens is used to create a three-dimensional (3-D) image by changing the focus of light passing through the fiber. The lens is also be used to direct the light that passes through the fiber. Directing the light yields a brighter image in a given location, and can optionally create multiple images. Note that 3-D and multiple-view reflective displays may require more than one fiber with a given lens function to create such images.

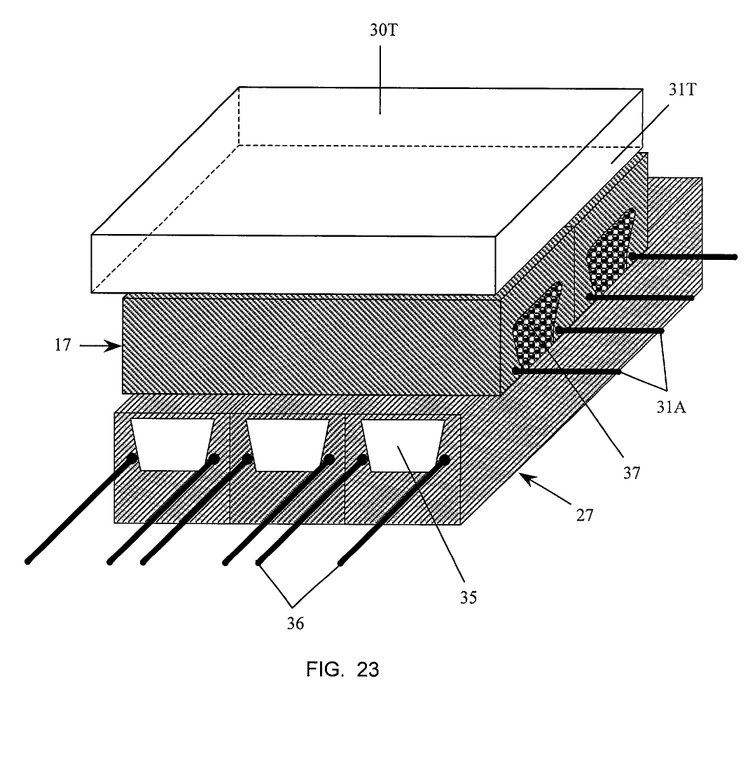

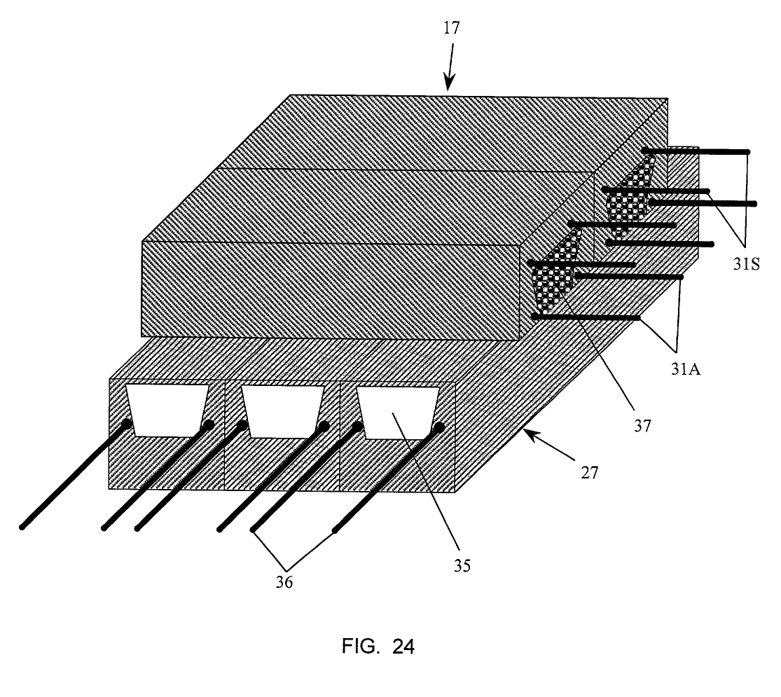

One problem in the art is addressing the plasma in the bottom fibers over a long distance and creating a vertical electric field through the electro-optic material. The display shown in FIG. 23 solves both of these problems. The bottom fibers 27 are used to address the plasma, as explained above. The top fibers 17 are designed to both support the electro-optic material 37 and address the plasma, using the wire address electrodes 31A. The top glass plate 30T has a transparent conductive layer 31T that is used as the ground plane for the plated-out charge in the plasma cells 35, hence creating an electric field through the electro-optic material 37. The extra set of electrodes 31A and ground plane electrode 31T make the display extremely easy to fully write or fully erase the electro-optic material 37. The ground plane electrode 31T is optionally included in the top fiber to create a total-fiber display, as shown in FIG. 24. In this case, the ground plane electrodes 31S are optionally individually addressed per each top fiber 17.

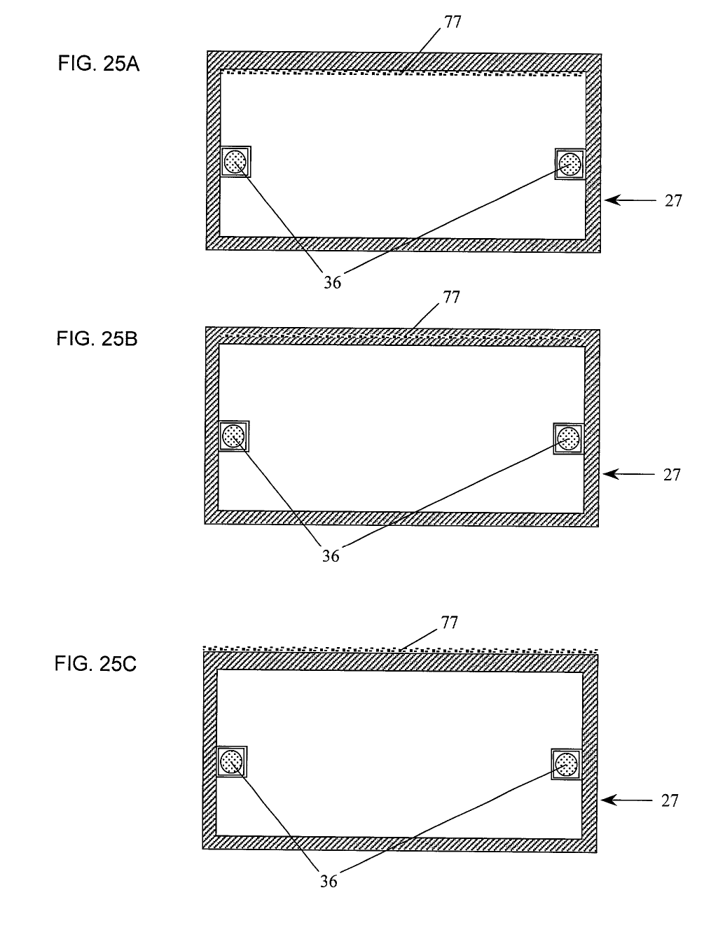

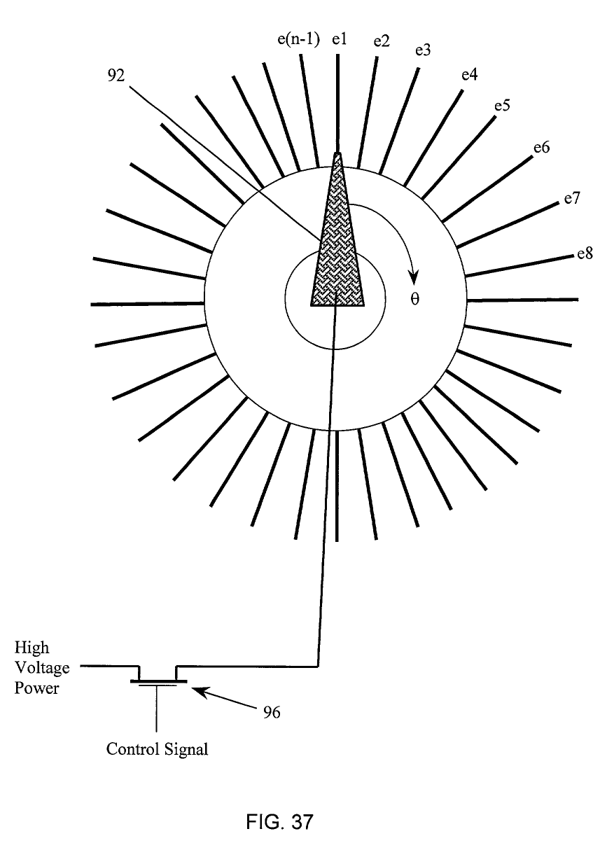

FIG. 25 illustrate a method of adding a charging electrode 77 to the hollow plasma tubes 27 to assist in addressing the display. The charging electrode 77 should be discontinuous along the length of the plasma tube 27. The charging electrode 77 could be composed of randomly distributed conductive particles. If a high density is required the conductive particles could be composed of a metal with an oxidized surface to create isolation between the metal particles. The conductive particles could also be mixed with a glass to isolate them. The charging electrode 77 could be added to the inside surface of the hollow tube 27, as shown in FIG. 25A, or inside the wall of the hollow tube 27, as shown in FIG. 25B, or on the outside surface of the hollow tube 27, as shown in FIG. 25C. The charging electrode 77 would serve a similar purpose as the traditional inside surface of the plasma tube 27 in storing charge to address the electro-optic material. But, the charging electrode 77 could be designed to not loose its charge during the firing of the plasma within the plasma tube 27. Therefore, allowing for a sequential addressing scheme of the address electrodes for each plasma tube. This sequential addressing scheme would allow for a reduction in electronics cost by using an electronics driver similar to that shown in FIG. 37.

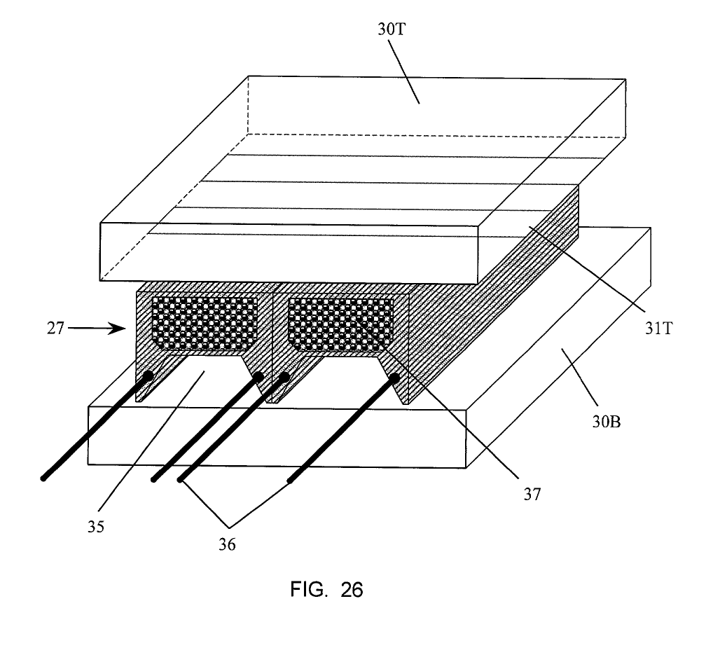

FIG. 26 illustrates a reflective display where the electro-optic material 37 is totally contained within the fiber 27. The electro-optic material 37 is addressed using a plasma similar to that explained above, but the plasma channel is formed by making a vacuum-tight seal between the fibers 27 and the bottom plate 30B, or between the two plates 30T and 30B. The plasma electrodes 36 are used to ignite the plasma in the plasma channel 35, and the transparent electrodes 31T on the top plate 30T, are used to pull the electrons out of the plasma and plate them out on the upper top surface of the plasma channel 35. In this display, like the above display, the plasma is addressed one line at a time along the plasma channels.

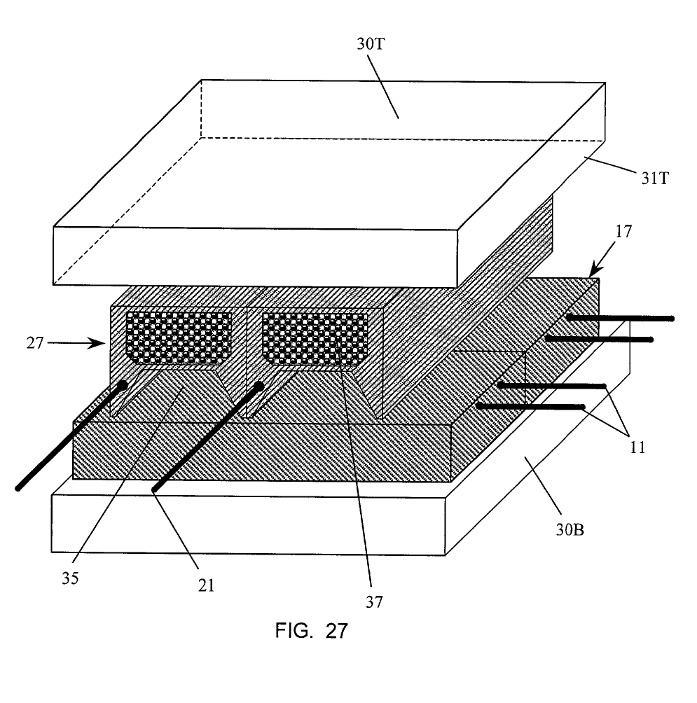

FIG. 27 illustrates a different method of addressing the plasma part of the display. The addressing technique is similar to that of a surface discharge plasma display. In this example, sets of parallel sustain electrodes 11 extend the length of the “top” fibers 17. An AC voltage is applied to the sustain electrodes 11, which is large enough to sustain a plasma, but not large enough to ignite the plasma. A short voltage pulse is then added to the plasma address electrodes 21 at the pixel location where addressing is desired. This short voltage pulse adds to the electric field of the sustain electrodes and locally ignites the plasma. After all the plasma cells are written, a voltage is applied to the top transparent conductive electrode 31T to pull the electrons out to the plasma and plate them out on the upper inside surface of the written plasma channels 35. After the electrons are plated out, the voltage on the transparent electrode 31T is removed, and an electric field is produced across the electro-optic material 37 as a result of the stored charge. A total-fiber display is optionally constructed by including the transparent electrode 31T into the “bottom” fiber 27, as shown in FIG. 28. In this case, wire electrode 31 serves as the address electrode for the electro-optic material.

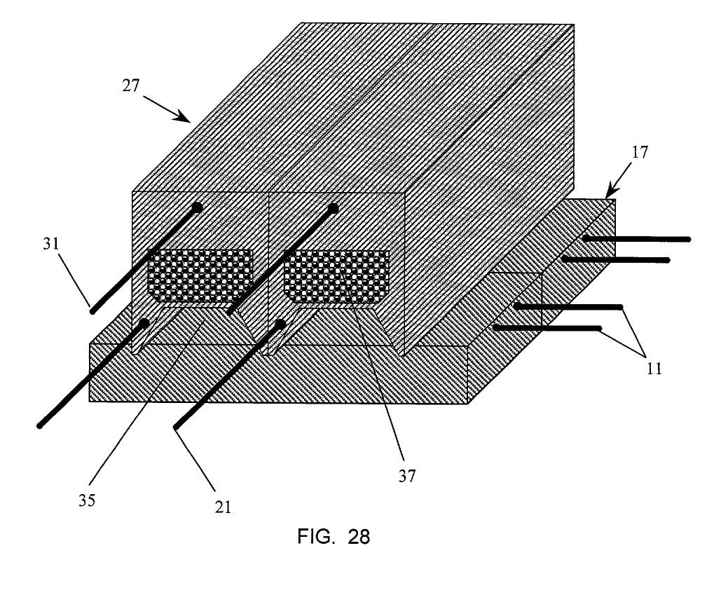

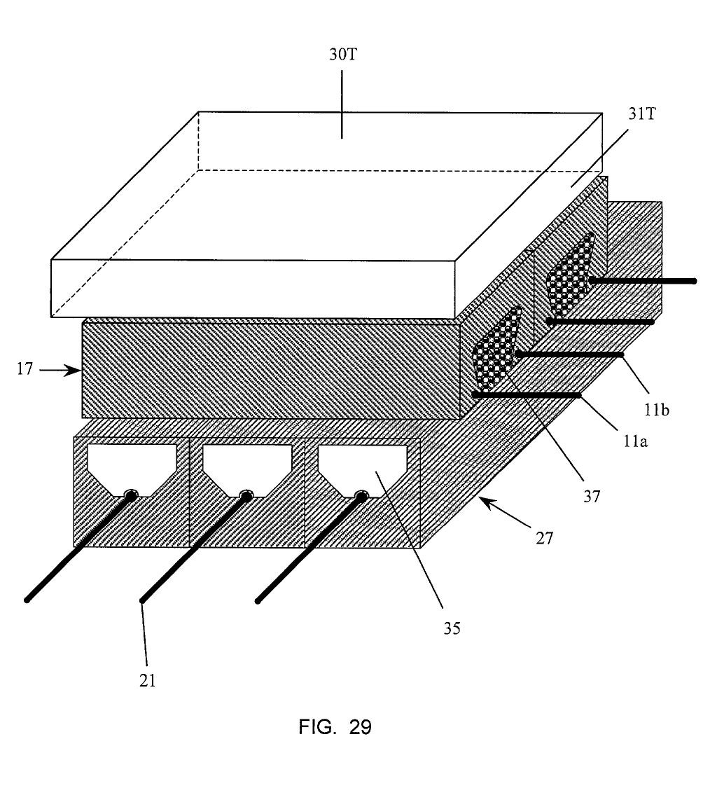

One potential problem with the reflective display discussed in FIGS. 26-28 is that the entire display will have to be glass frit sealed around the perimeter of the display to contain the plasma gas. This glass frit-sealing step usually requires a process temperature of about 400° C., which could cause harm to the electro-optic material, especially if it is composed of an organic material. One method of addressing the plasma at each pixel in the display and containing the plasma in individual tubes is shown in FIG. 29. In this figure, sustain electrodes 11a and 11b along with the electro-optic material 37 are contained in one fiber 17. This fiber array 17 is placed over and orthogonal to a second fiber array 27 that contains the address electrode 21 and the plasma cell region 35. There are two traditional methods used to address a capacitively coupled plasma. The first is to essentially tie electrodes 11a and 11b together and use them as one electrode and electrode 21 as the other. Applying a voltage between the electrodes (11a, 11b) and 21 will ignite the plasma in the plasma cell region 35 at the crossing of the two electrodes. The plasma is sustained by applying an AC voltage between the electrodes. During the AC voltage electrons are swept back and forth between the address electrodes. These electrons plate out on the dielectric material around the electrode and are used to assist the igniting of the plasma in the next cycle of the AC voltage. Therefore, these electrons can be used to address the electro-optic material by choosing the proper phase of the AC voltage to stop the plasma addressing. If the pixel is to be ON, i.e. the electro-optic material is to be modulated, then the last plasma addressing of the pixel should be with a positive voltage on electrodes 11a and 11b. Likewise, if the pixel is to OFF then the positive voltage should be applied to electrode 21 during the last plasma addressing cycle. Choosing the phase to stop the plasma addressing will determine whether or not there are electrons plated out at the top of the plasma channel 35 to address the electro-optic material 37. These plated-out electrons serve to create a field between the electro-optic material by communicating with the electrode 31T above the electro-optic material 37. In addition, the electrode 31T on the top plate 30T can be replaced with wire electrodes 31S at the top of the fiber 17, as shown in FIG. 24. The second traditional method of addressing the plasma at each individual pixel is to apply an AC voltage between electrodes 11a and 11b that is high enough to sustain a plasma, but not high enough to ignite a plasma in the plasma cell region 35. Then by applying an address voltage to electrode 21 the plasma can be locally ignited. Each phase of the AC will result in electrons, which are plated out on the dielectric layer around one of the sustain electrode, leaving the sustain electrode (11a), creating a plasma glow, and plating out around the other sustain electrode (11b). The only way electrons will be plated out around any electrode is if a high enough electric field exists to ignite the plasma and create ionization/electrons. Therefore, if the pixel is written then electrons are plated out on the top of the plasma channel 35 and can be used to address the electro-optic material. One potential problem with this second addressing scheme is that the electrons are plated out locally around one of the two sustain electrodes, 11a or 11b, depending on which phase of the AC was last used. This local collection of electrons may result in incomplete addressing of the electro-optic material 37 because of the non-uniform electric field through the electro-optic material 37. One method of combating this problem is to use adjacent pairs of sustain electrodes as single sets of sustain electrodes. Combining the sustain electrodes can be done by simply tying each pair of sustain electrodes 11a and 11b together and use them as a single sustain electrode (11a). The second sustain electrode (11b) will result by tying an adjacent sustain electrode pair together. Using an interlaced addressing technique will be the best method of addressing the entire display, since each fiber 17 only contains one of the sustain electrodes. However, tying the two sustain electrodes 11a and 11b together will allow for the plasma to spread over the top of the plasma channel 35 in the bottom fiber 27 below and between the sustain electrodes 11a and 11b. These electrons can them be used to address the electro-optic material 37.

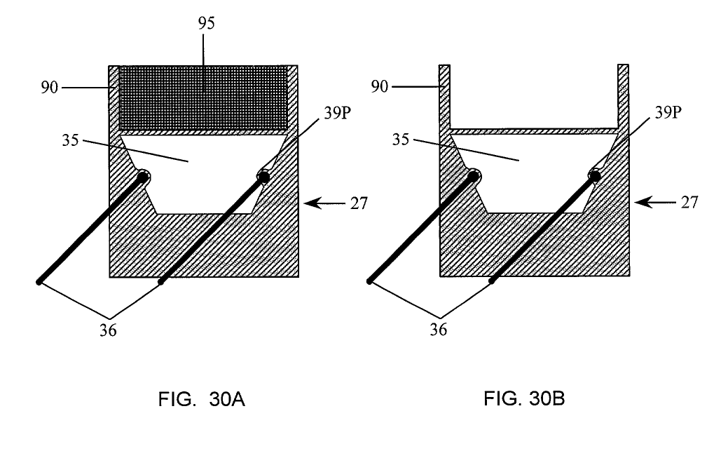

One potential difficulty in fabricating these complex-shaped fibers is maintaining the tight tolerances and holding the exact shapes. A lost glass or lost plastic process is optionally used to create the exact desired shape, as shown in FIG. 30A and 30B. In this example, an etchable or dissolvable material 95 is added to the preform before the fiber draw, to maintain the thin narrow vertical ribs 90 and hold the top of the plasma channel 35 as flat as possible. FIGS. 30A and 30B also show a contoured glass membrane 39P around the plasma address electrodes 36. This contoured membrane 39P creates a more uniform field upon addressing, and creates a larger surface area for free carrier annihilation after plasma discharge.

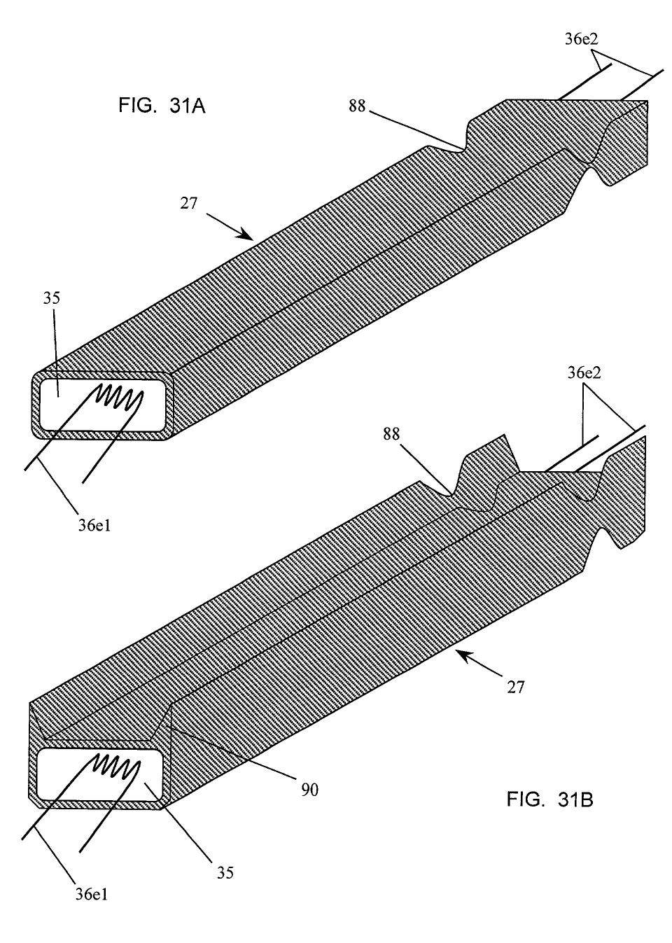

FIG. 31A shows that the plasma within the tubes could be ignited using electrodes 36e1 and 36e2 at the ends of the tubes 27. In this case, the drawn-in wire electrodes are replaced with two electrodes at each end of the plasma tube. Electrodes 36e1 and 36e2 at the ends of the plasma tubes will only be useful in larger tubes since the firing voltage will be too high in small tubes as a result of wall quenching of the ionized gas. The tubes can be sealed at the ends by using a glass sealing frit or by locally heating the tube while the inside is at a lower pressure, hence collapsing the tube 88 onto itself and sealing it off. The ribs 90 to support the electro-optic material could also be designed into the tubes and electrodes 36 sealed into the ends, as shown in FIG. 31B.

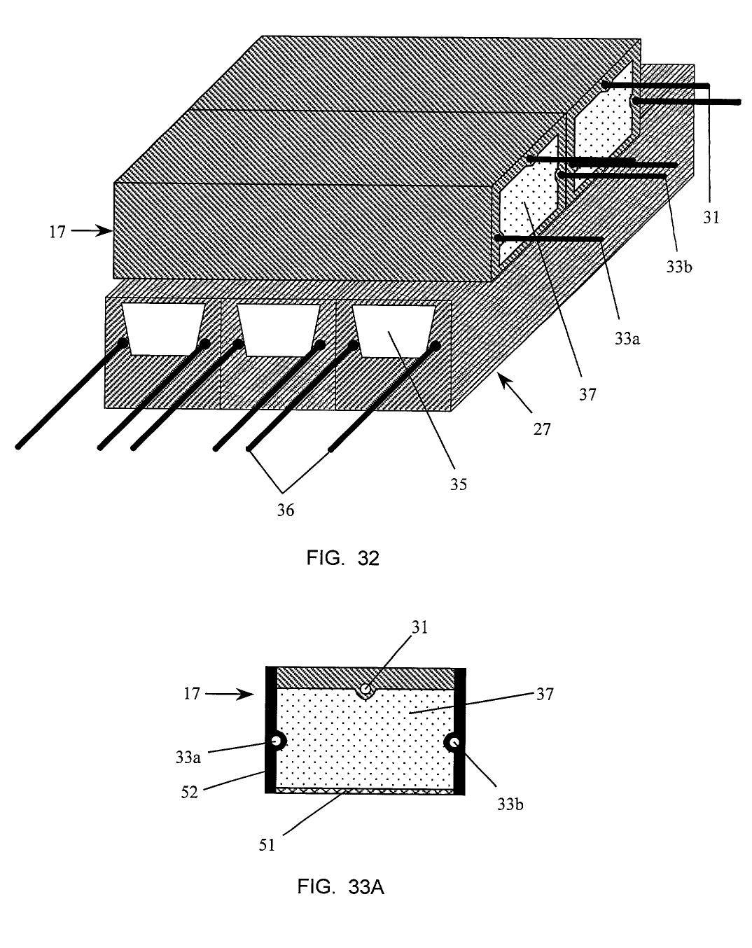

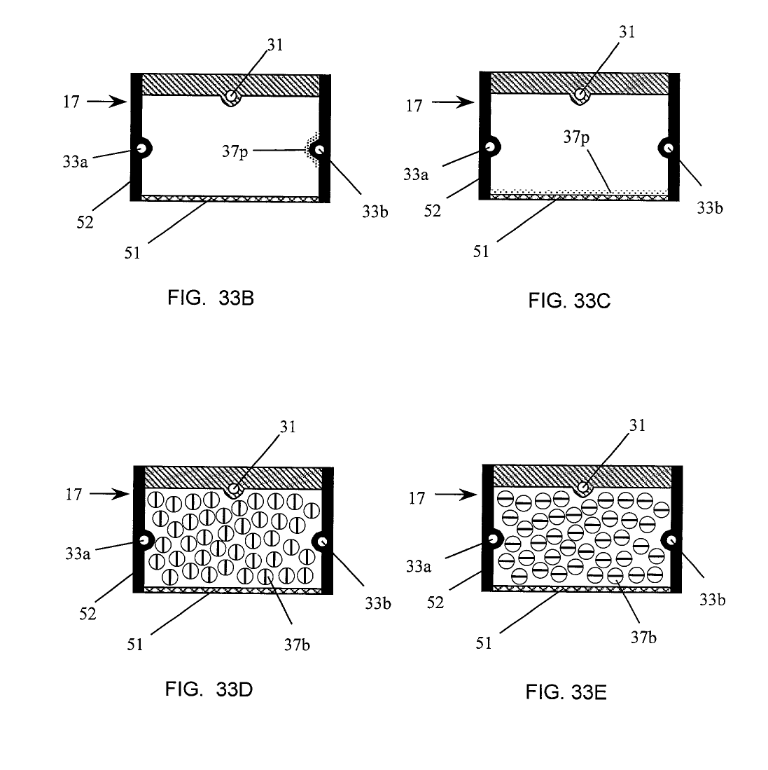

FIG. 32 represents a fiber-based display that can be operated in both a transmissive and reflective mode, referred to as a transflective mode. The display has an array of bottom fibers 27 that have plasma tubes 35 to address the electro-optic material by plating out charge like stated above, however since the display has to work in a transmissive mode the fibers 27 have to be clear or translucent. The top fibers 17 have at least three sets of electrodes and a channel for the electro-optic material 37. The two set of side electrodes 33a and 33b are used to address the electro-optic material in the plane of the display and electrode 31 is used to modulate the electro-optic material 37 using the charge from the plasma 35 similar to that discussed above. It will be beneficial to design a black matrix 52 into the top fiber 17 as shown in FIG. 33A. This black matrix will create a sharper image and block the light not going through the electro-optic material. In addition, a reflective layer 51 could be added to the bottom of the top fiber 17. This reflective layer 51 could be included in the top fiber 17 or could be coated on the surface of the fiber. If the top fiber 17 is composed of glass the bottom of the fiber could be composed of an opal glass, which will reflect the light, but also let some of the light pass through. It would be preferred to fabricate the top fiber 17 out of plastic because of weight and ease of formation. If a polymer material is used to fabricate the top fiber 17 a reflective material could be used that would allow light to pass through if coming from underneath but reflect light coming through the electro-optic material. A coating could also be applied to the fiber preferably on the outer surface. This coating could act similar to a one-way mirror, where light coming through the fiber is reflected, however light coming from underneath is passed through.

The two preferred electro-optic materials 37 for the transflective display are the bichromal sphere (Gyricon) and electrophoretic material. One potential operation of the display using an electrophoretic material is to fill the electro-optic channel with a dilute solution of absorbing particles 37p in a colored or clear liquid. Then by applying a voltage between electrodes 33a and 33b the absorbing particles 37p will move through the liquid to one of the two contact, as shown in FIG. 33B. Moving the absorbing particles to one of the two electrodes, 33a or 33b, will open-up the center region of the top fiber 17 for light to pass through. Assuming the display is being back-lit then the light can pass directly through the display. If the display is being operated in a reflective mode and there is a reflective material 51 on the bottom side of the top fiber 17 or the bottom fiber 27 is reflective then light traveling through the display will be reflected back out of the display. If color is desired then either the top fiber can be coated with a color die, or be composed of a colored material, or the electrophoretic liquid solution could be colored. To change the gray scale of the display or make it dark the absorbing particles 37p can be moved to the bottom of the electro-optic cell region, as shown in FIG. 33C. The absorbing particles can be attracted to this surface by addressing the display using the plasma channel 35 and the addressing electrode 31 as discussed above. Voltages could also be applied to the side electrodes 33a and 33b to create the proper electric field to assist in moving the absorbing particles to the bottom of the electro-optic cell region 37. Gray scale can be achieved by only moving part of the absorbing particles 37p to the bottom of the electro-optic cell region 37.

Creating a transflective display using bichromal spheres is similar in operation to that using electrophoretic materials except that bichromal spheres are only rotated and not translated. FIG. 33D shows one potential position of the bichromal spheres when a voltage is applied in the plane of the display or between electrodes 33a and 33b. In this example the bichromal spheres 37b are clear or colored with an absorbing material in a slice through the center of the sphere. When light passes through the display it is effected little by the spheres 37b since the light is travelling in the same direction as the plane of the absorbing layer. Color could be added to the fiber 17 as discussed above or it could be added to the spheres 37b. The color could also be added to the liquid solution or polymer material that suspends or holds the spheres 37b in the electro-optic region 37. Changing the gray scale is achieved by addressing the pixel using the plasma channel 35 and the electro-optic address electrode 31 as discussed above. Different levels of gray scale can be achieved by only rotating some of the spheres or by rotating them to a given angle.

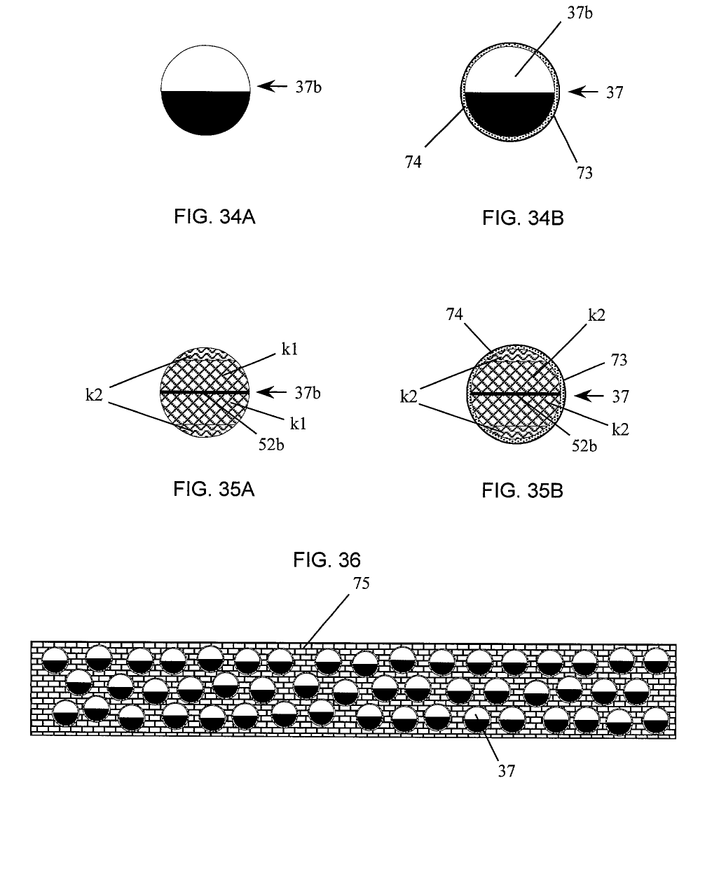

FIGS. 34 and 35 represent two types of bichromal spheres that can be used as an electro-optic material. FIG. 34A shows a bichromal sphere 37b where one half of the ball is black and the other half white. The bichromal sphere is composed of two dissimilar materials that have two different zeta potentials, which generate positive and negative surface charges when placed in contact with a liquid. These different surface charges are what makes the bichromal spheres rotate when placed in an electric field. FIG. 35A shows a bipolar sphere 37b with a center light absorbing or reflecting medium 52b sandwiched between two dissimilar materials with different dielectric constants k1 and k2. If one of the two dielectric constant materials k1 or k2 changes with respect to an applied electric field then the bipolar sphere 37b can be rotated with respect to the direction of the electric field and the frequency of the electric field as described in U.S. Pat. No. 4,261,653.

In order to rotate either of the bichromal spheres in FIGS. 34A or 34b they need to be floating in a fluid. FIGS. 34B and 35B show that a sac 73 can be created around the spheres 37b and a fluid 74 can be filled between the sphere 37b and the sac 73. The sac 73 around the sphere 37b can be formed using the traditional method of coating the spheres 37b with a polymer film 73 and then swelling the film with a plasticizer to form a void around that sphere 37b that can be subsequently filled with an oil 74. Another method of creating the sac 73 around the sphere 37b is to coat the sphere 37b with a sacrificial film and overcoat the sacrificial film with the sac 73. Then by using a thermal or chemical process the sacrificial film can be removed leaving a void to be filled with a lubricating fluid 74. These fluid 74 filled sacs 73 of spheres 37b can then be placed in a clear polymer film 75 to form a sheet of twisting ball material, as shown in FIG. 36. One advantage of starting with fluid 74 filled sacs 73 of spheres 37b is that a non-permeable polymer film 75 can be used to house the twisting ball material 37 such that no fluid can penetrate to the surface of the film, thus allowing for the fabrication of electronic paper.

FIG. 37 illustrates a method of designing electronics to address the display using a rotating wiper blade 92 to sequentially add the high voltages to the electrodes (e1 through e(n−1)) of the display. The high voltages can be applied to each line (e1 through e(n−1)) of the display using a single transistor 96 attached to the rotating wiper blade 92. Using one high voltage transistor 96 to address each line of the display will result in a very large cost reduction over using a high voltage transistor 96 for each line of the display. Since the plasma electrodes are sequentially addressed in the above mentioned electro-optic displays this type of addressing electronics would very suitable to address those displays. Another sequentially addressing drive mechanism would be a linear drive where the wiper blade 92 is translated along a line of electrodes (e1 through e(n−1)) sequentially making contact and addressing each electrode using a high voltage transistor 96 attached to the wiper blade 92.

A further embodiment of the invention includes the use of fibers mainly in the form of hollow tubes with wire electrodes and barriers to construct reflective fiber-based displays. Modulating an electro-optic material within the display forms the reflectivity. The wire electrodes are contained within the fiber or on the surface of the fiber. The barriers are either structural barrier walls or created by an electric field from a wire electrode and assist in matrix addressing the display. The fibers or tubes are optionally colored to impart color to the display and can also be partially black to serve a black matrix function which enhances the contrast and sharpness of the display. Alternatively, the fibers or tubes can be white to enhance the reflectivity of the display. The electrophoretic material may also be colored to add color to the display. The fibers or tubes are preferably composed of glass, glass ceramic, plastic/polymer, metal, or a combination of the above.

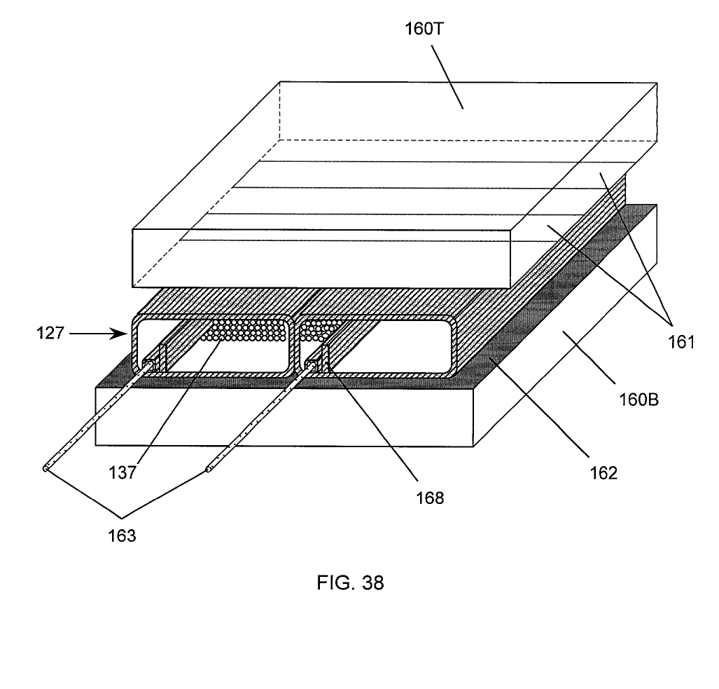

FIG. 38 shows a schematic of a structural barrier type in plane switching electrophoretic display using hollow tubes 127 containing barrier walls 168 and wire drive electrodes 163. The height of the physical barrier wall 168 extends less than 100% of the height of the inside of the hollow tube 127, leaving a gap between the barrier wall 168 and the top of the hollow tube 127. The array of tubes 127 are sandwiched between two plates 160T and 160B. The top plate 160T has parallel address electrodes 161 to modulate the flow of electrophoretic particles 137 in the hollow tubes 127. The bottom plate 160B is blanket coated with a second planar drive electrode 162, which is used to attract the particles to the bottom of the hollow tubes 127. Addressing the display is accomplished by applying voltages on the wire drive electrodes 163 and the address electrodes 161 to create an electric field to force the electrophoretic particles 137 to flow over the barrier walls 168, if the pixel is to be dark (a written state).

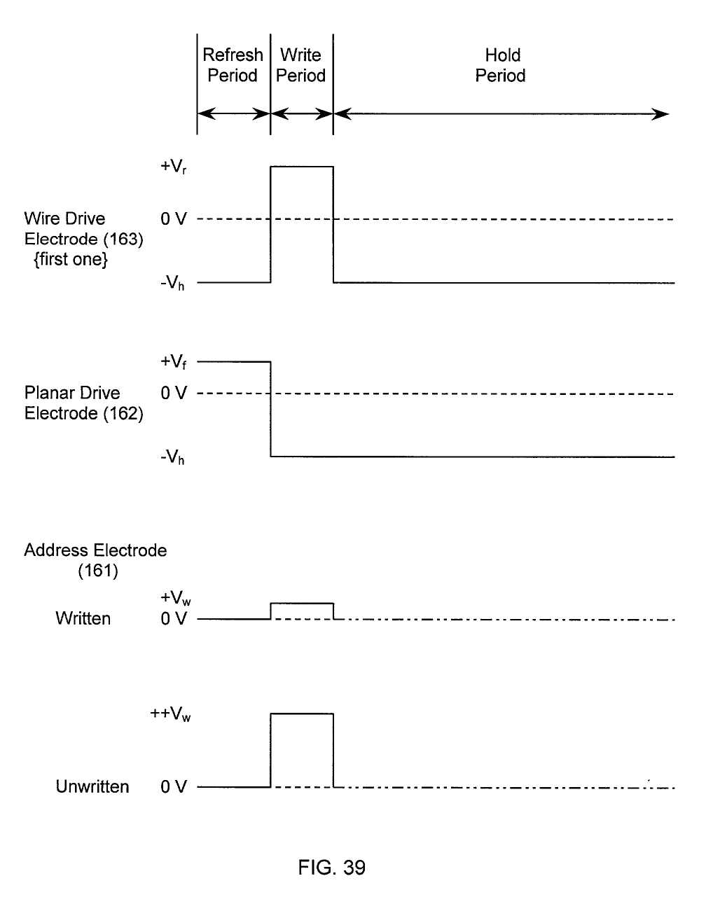

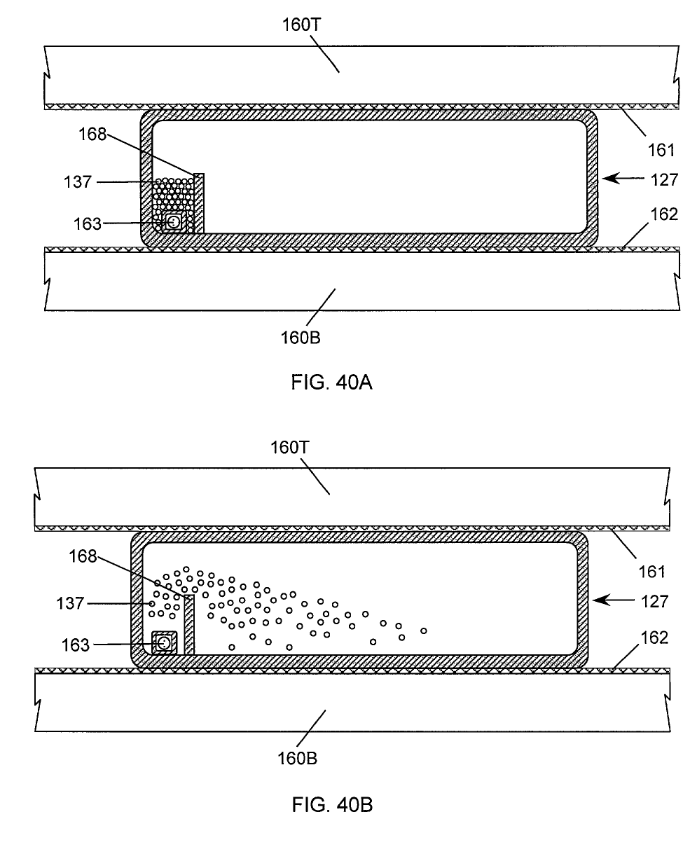

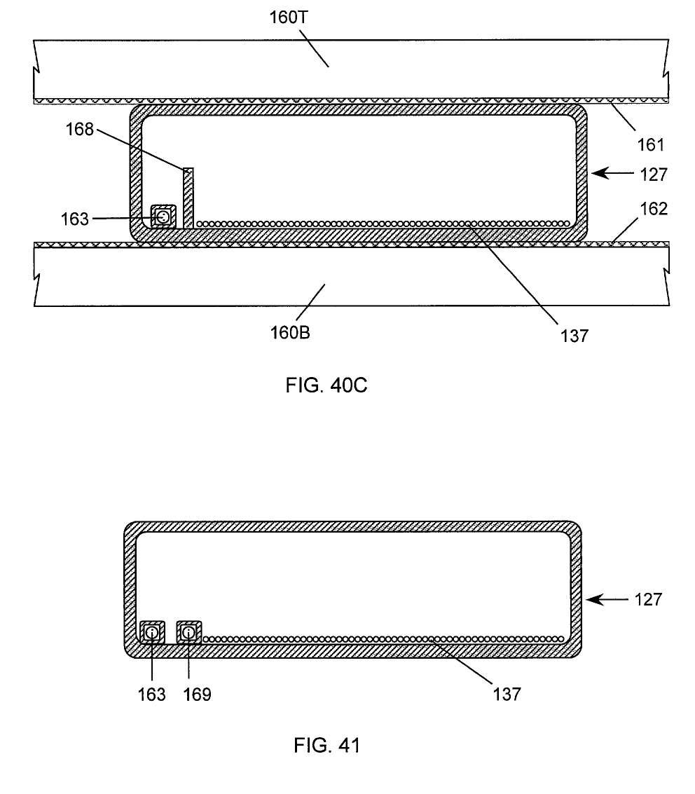

FIG. 39 shows typical voltage waveforms to address a pixel in the display. The three periods of addressing, the refresh period, the write period and the hold period, are pictorially represented in FIGS. 40A, 40B, and 40C, respectively. The voltage pulses and representative figures assume that the electrophoretic particles are positively charged. During the refresh period a negative holding voltage, −Vₕ, is applied to the wire drive electrode 163 to attract the particles 137 and a positive refresh voltage, +V_{f}, is applied to the planar drive electrode 162 to repel the particles 137. Under these voltage conditions, the particles 137 collect around the wire drive electrode 163, as shown in FIG. 40A. To place the pixel in a written state, particles must flow over the barrier wall and be collected on the surface of the hollow tube. This flow of particles is accomplished by applying a positive repulsive voltage, +Vᵣ, to the wire drive electrode 163 to repel the particles 137 from the wire drive electrode 163. A second positive write voltage, +V_{w}, is applied to the orthogonal address electrode(s) 161 to control the flow of particles 137 over the barrier wall 168, as shown in FIG. 40B. The magnitude of the write voltage, +V_{w}, determines if the particles 137 flow over the barrier wall 168 or not. If a large write voltage, ++V_{w}, is applied to the address electrode 161, then the particles 137 are forced to stay below the barrier wall 168 and the cell is in an unwritten state. Whereas, if a small write voltage, +V_{w}, is applied, then the positive voltage from the wire drive electrode 163, +Vᵣ, creates a large enough repulsive field to force the particles 137 to flow over the barrier wall 168. A negative voltage, −Vₕ, is also applied to the planar drive electrode 162 to attract the particles 137 that flow over the barrier wall 168 to the bottom of the hollow tube(s) 127, as shown in FIG. 40C. Once the cell has been written (or not), the voltage on the wire drive electrode 163 is reduced to a negative holding voltage, −Vₕ, to attract any remaining particles 137 that have not made it over the barrier wall 168 and allow the next hollow tube 127 row of the display to be addressed. The address voltages, +V_{w}, are then modulated to address the subsequent rows (hollow tubes) in the displays. Note that the planar drive electrode 162 stays at a negative hold voltage, −Vₕ, until the remainder of the display is written and the display is ready to be refreshed.

Gray scale images are optionally created in the display by controlling the write voltage, +V_{w}, on the address electrode 161. Controlling the magnitude of this voltage controls the strength of the repulsive electric field, hence controlling the amount of particles 137 that flow over the barrier wall(s) 168. Reducing the magnitude of the write voltage, +V_{w}, on the address electrode 161 in turn leads to an increased number of particles that surmount the barrier wall(s) 168.

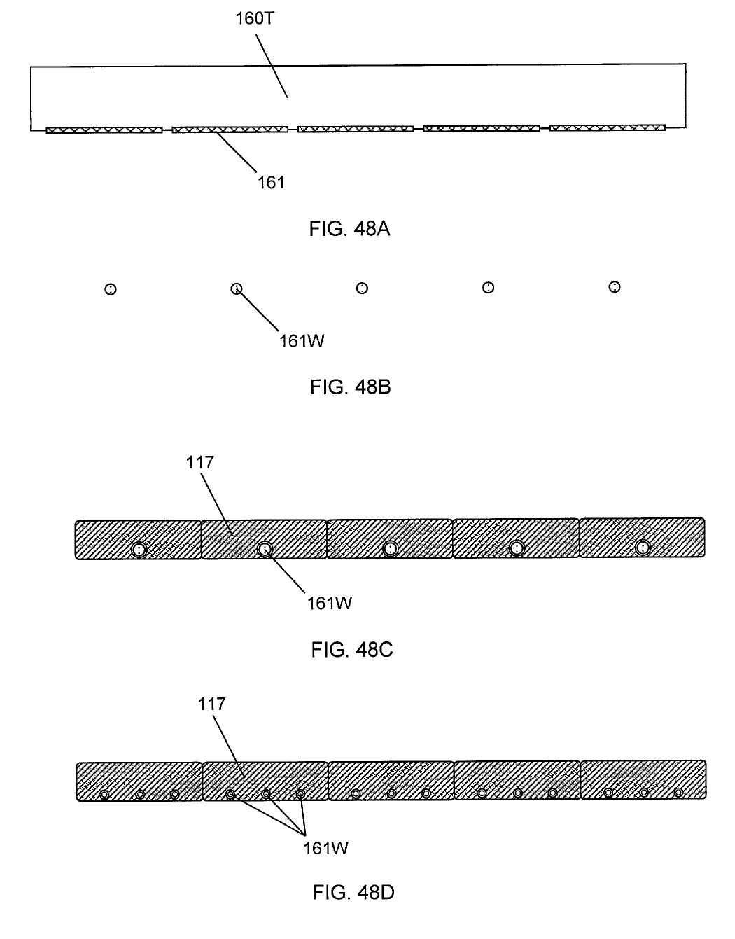

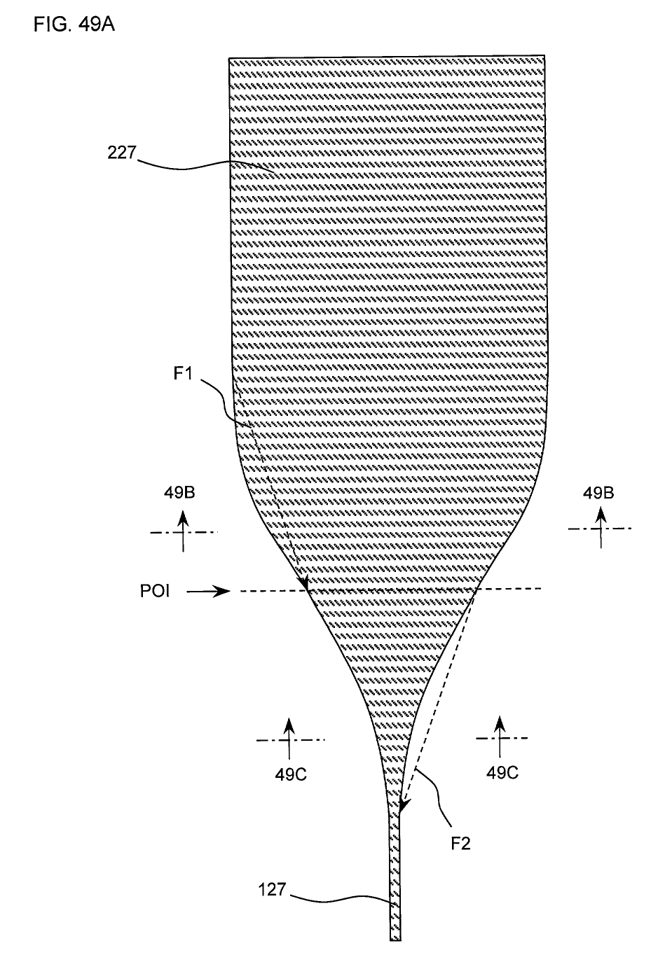

Another method of creating a gray scale image divides the addressing time into sections or bits, similar to the addressing scheme of a plasma display. The amount of time that the write voltage, +V_{w}, on the address electrode 161 is reduced to near zero voltage during the addressing period of a single frame determines the amount of particles 137 that flow over the barrier wall(s) 618. In a preferred embodiment, this time modulating addressing scheme is combined with a JPEG image and the image on the display is written similar to the flow of information from a JPEG image (i.e. the image is written in an intensity map sequence). A third method of creating gray scale breaks the address electrode 161 into several electrodes, similar to that shown in FIG. 48D. The multiple address electrodes can have different widths to control the flow of particles from a larger area.

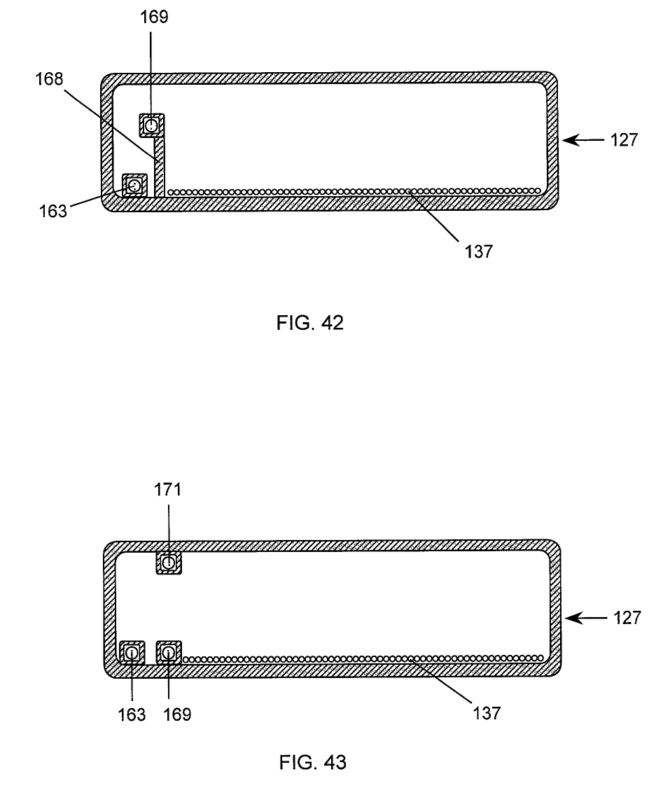

The barrier wall 168 in the hollow tube(s) 127 may be replaced with a barrier electrode 169, similar to that shown in FIG. 41. This barrier electrode 169 serves the same purpose as the barrier wall 168 discussed above. The barrier is created by applying a positive voltage to the barrier electrode 169 in turn creating a repulsive barrier for the particles to cross over. The size or height of the barrier is determined by the magnitude of the voltage applied to the barrier electrode 169. The barrier wall 168 and barrier electrode 69 can both be combined into one hollow tube 127 to create a compound barrier, as shown in FIG. 42. This compound barrier yields a much tighter control on the movement of particles 137 across the barrier region. The barrier electrode 169 can be combined with the barrier wall 168 at any location within the barrier wall 168.

FIG. 43 shows a cross-section of a hollow tube 127 where the barrier is a gate created by a barrier electrode 169 and a control electrode 171. There are two different methods of operating this type of barrier. The first method creates a gate using the barrier electrode 169 and the control electrode 171. This gate is large enough to keep any particles 137 from passing through it. Then, by applying a negative voltage on the orthogonal address electrode(s) 161 (not shown, see FIG. 38), the gate is locally reduced and particles 137 can pass through it. The other method uses the barrier electrode 169 and control electrode 171 to create a gate weak enough for particles 137 to penetrate through it. Then, by applying a positive voltage on the orthogonal address electrode(s) 161 the gate can be selectively closed to particle 137 flow. The wire drive electrode 163 can be attached to the sides of the hollow tube between the barrier electrode 169 and the control electrode 171 so the particles have a more direct line of sight to the center of the electrostatic gate.

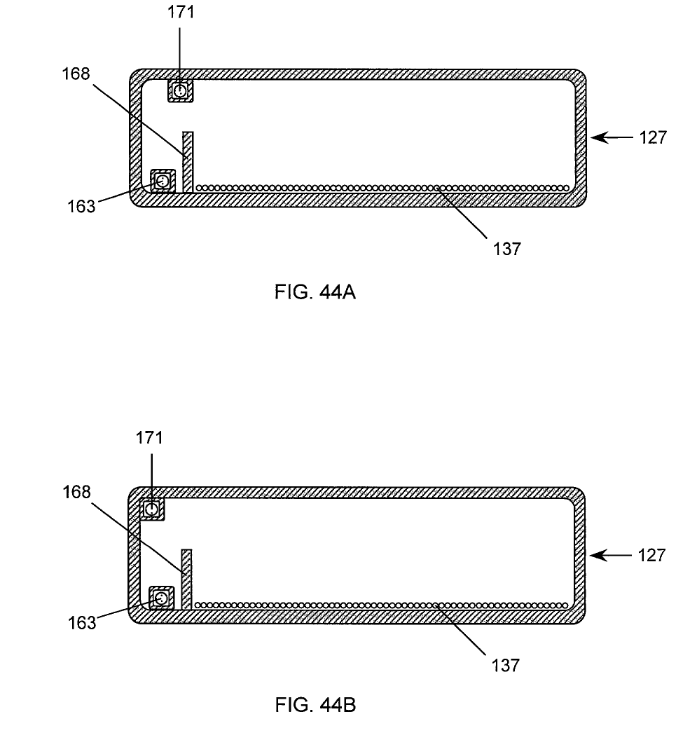

FIG. 44 shows a gate that is created using the barrier wall 168 and a control electrode 171. FIG. 44A shows the control electrode 171 located directly above the barrier wall 168 and FIG. 44B shows the control electrode 171 in the corner of the hollow tube 127. Adding a control electrode 171 allows for many different addressing schemes. But, the largest advantage of adding a control electrode 171 is to even out the particles 137 along the length of the hollow tube 127. During the operation of the display, particles start to aggregate to one location in the hollow tube as the image in that area of the display is continuously written dark. Applying an alternating voltage between the control electrode 171 and the wire drive electrode 163 evenly redistributes the particles. This reconditioning of the distribution of particles is imperative for a display with an even gray scale and color distribution across the display. In addition, the control electrode 171 greatly assists in returning the particles to the wire drive electrode 163. Due to the blocking of the barrier wall, applying a negative voltage to the control electrode 171 pulls the particles 137 from the large volume of the hollow tube 127 much easier than applying the voltage to the wire drive electrode 163.

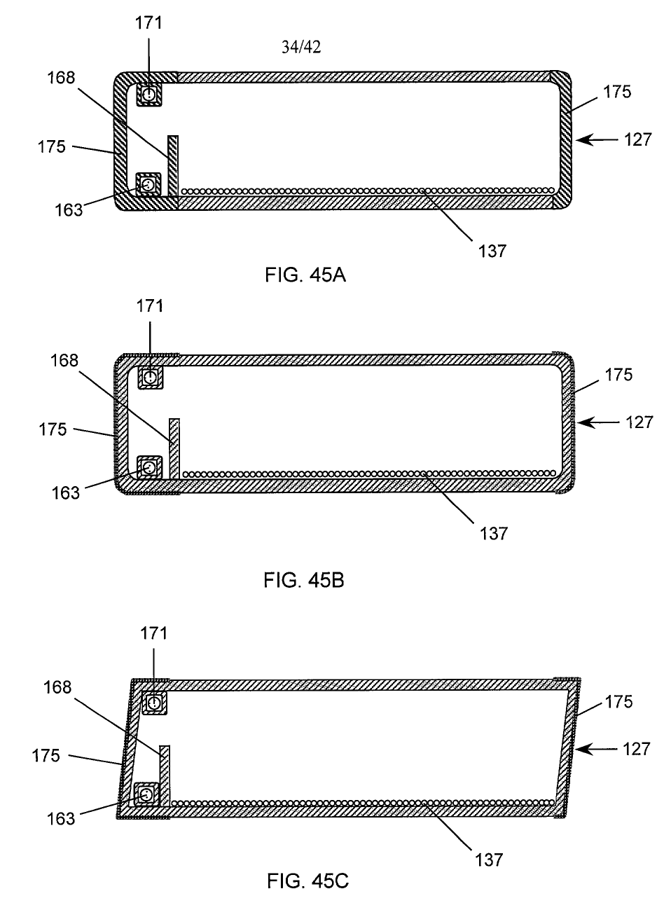

In order to increase the contrast of the display, light absorbing regions 175 must be added to the sides of the hollow tubes 127, as shown in FIG. 45. These light absorbing regions 175 function as a black matrix and keep light from penetrating through the unmodulated regions of the display. FIG. 45A shows that the black absorbing region 175 is contained within the hollow tube 127. Alternatively, the black absorbing region 175 is coated on the ends of the hollow tube 127, as shown in FIG. 45B. Both FIGS. 45A and 45B block the unwanted light within the hollow tube, but light still can be transmitted between the hollow tubes 127 if they are not in intimate contact. However, by designing the hollow tubes 127 in an interlocking mechanism or simply slanting the side of the hollow tubes 127, similar to that shown in FIG. 45C, the light transmission between the hollow tubes 127 is blocked.

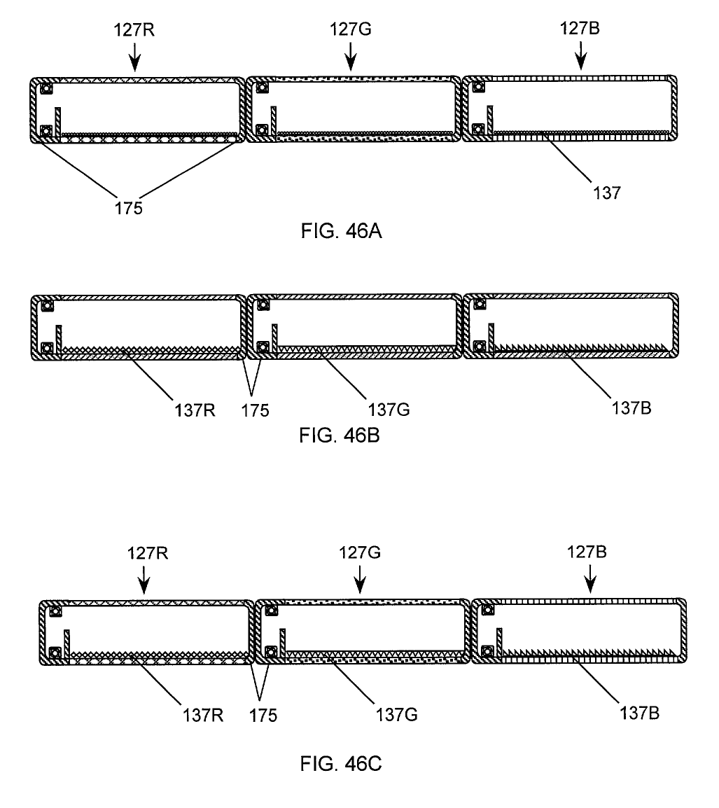

FIG. 46 shows several ways to add color to the display. Color is added to the display by fabricating the hollow tubes (127R, 127G, 127B) from a color material, as shown in FIG. 46A, or by coating the hollow tubes with a colored die. The color die is coated on either the inside or outside of the hollow tubes. The colored die and/or black matrix can be coated on the tubes (127R, 127G, 127B) during the draw process. This can be done using several different methods, the most promising method being spraying or drawing the tubes (127R, 127G, 127B) over or past a coating system.

Coating the tubes (127R, 127G, 127B) with both the black matrix material 175 and color filter material requires two different coating systems. The first system coats the sides with an absorbing black matrix material 175, while the second system coats the top, bottom or both top and bottom with a particular color film (red, green, or blue) to create the color in the display. Color can also be added to the display by either making the particles (137R, 137G, 137B) different colors in the hollow tubes, as shown in FIG. 46B, or by making the liquid medium the particles 137 reside in colored. To achieve the best color quality in the display, both the hollow tubes (127R, 127G, 127B) and electrophoretic particles (137R, 137B, 137G) have to be colored, as shown in FIG. 46C.

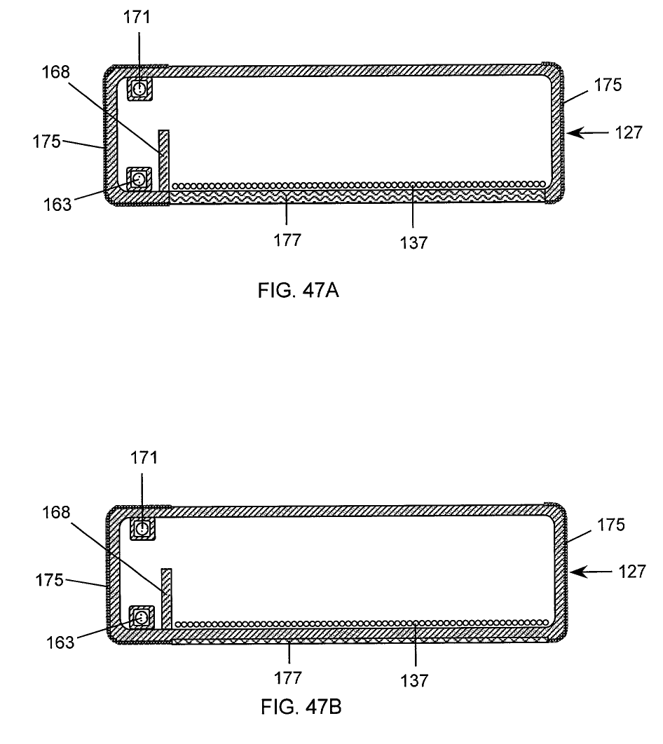

Reflectivity in the display is achieved by using a reflective conductive planar drive electrode 162, shown in FIG. 38. Using a highly reflective metal film for this electrode 162 yields a high reflectivity, however the display only functions in a reflective mode. To fabricate a transflective display that can be operated in both a reflective and transmissive mode, the reflecting material must be both transmissive and reflective. An example of one such material is a conductive coating that is used in a one-way mirror, where the mirror side faces the viewer. Therefore, when there is a high level of incident light on the display, it functions in a reflective mode, but when the background illumination level is low, the display is back illuminated and functions in a transmissive mode. The reflectivity of the display can also be included in the hollow tubes 127, as shown in FIG. 47. FIG. 47A shows the reflective layer 177 as part of the hollow tube 127. If the hollow tube 127 is composed of glass, this reflective layer 177 is preferably an opal glass. Alternatively, if the hollow tube is composed of plastic, then white pigment or colorant could be added to the polymer blend to form the hollow tube(s) 127. The reflective layer 177 could also be added to the surface of the hollow tube 127, as shown in FIG. 47B. This reflective coating 177 could be a simple white paint and/or could be conductive and serve as the planar drive electrode 162.

In order to create very large displays, it is advantageous to replace the patterned address electrodes 161 on the top plate 160T with wire address electrodes 161W, as shown in FIG. 48. FIG. 48A shows a cross-section of a typical patterned top plate 160T with the transparent address electrodes 161, similar to that shown in FIG. 38. These address electrodes 161 are replaced with an array of wires 161W, as shown in FIG. 48B. One potential problem with using individual wires as the address electrodes 161W is holding the wires on a given pitch or separation. To alleviate this problem, the wires are held in the exact location by adding a transparent flowable film between the top plate 160T and the hollow tubes 127. This flowable film not only holds the wire address electrodes 161W in place but also removes the light reflection at that interface.

Another method to maintain the correct pitch is to include the wire address electrodes 161W in a fiber similar to that shown in FIG. 48C. In this case, arraying the fibers 117 into a compact sheet places the wire address electrodes 161W on a specified pitch. Since the wire is made as thin as possible to allow for the maximum amount of light to be transmitted through the display, the electric field created by the wire is narrow. One potential solution to this problem is to add more than one wire address electrode 161W per fiber 117, as shown in FIG. 48D. Multiple wire electrodes 161W spread out the electric field and the thin or small diameter of the wire minimizes the obstruction of light passing through the display.

Another potential problem with fabricating a high quality reflective display is the reflection at the interfaces between the plates 160 and the hollow tubes 127 or fibers 117. These additional surfaces create reflections, which lowers the contrast ratio of the display. To reduce or eliminate these reflections, a flowable polymer material is optionally included into the structure between the plates 160 and the hollow tubes 127 or fibers 117. A polymer material, such as, for example, ethylvinyl acetate (EVA), is optionally used to remove these reflections. In addition, it is advantageous to match the index of refraction of the plates, fibers/tubes, and electrophoretic solution to reduce reflections.

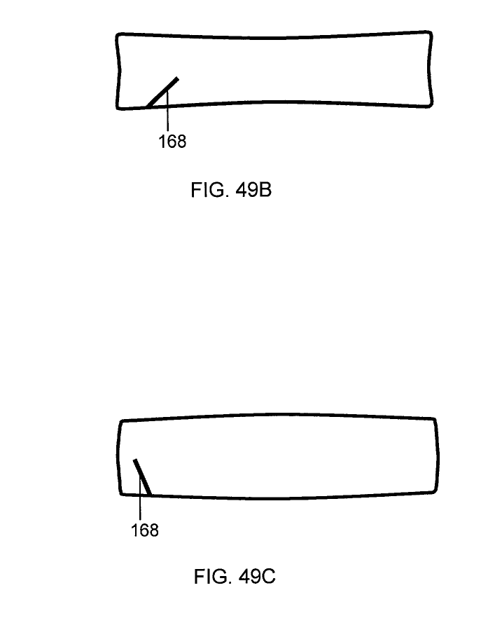

To fabricate the hollow tubes 127 and fibers 117, larger size preforms 227 are drawn into smaller sizes 127, as shown in FIG. 49A. The art of including the wire electrodes and forming the arrays of hollow tubes 127 or fibers 117 is explained in copending U.S. application Ser. No. 09/299,350, filed Apr. 26, 1999, entitled “PROCESS FOR MAKING ARRAY OF FIBERS USED IN FIBER-BASED PLASMA”, which is hereby incorporated herein by reference. During the “fiber draw” process, the shape of the hollow tubes and barrier wall 168 is altered. This shape change is a result of forces exerted on the tube and wall in reducing the size from a preform 227 to a hollow tube 127. The section of the “fiber draw” where the “fiber” is reduced in size is called the root of the draw. In the root of the draw, there are two normal forces that act on the “fiber”. At the top of the root the force (F1) acts to pull all points to the centerline of the preform/fiber. This force (F1) is present until the root goes through the point of inflection (POI), the point at which the curvature of the root goes from concave outward to concave inward. The resulting change in shape of the hollow tube and barrier wall 168 is shown in FIG. 49B, a cross-sectional view of FIG. 49A. Note that the force (F1) pulls the top of the barrier wall 168 and the sides of the hollow tube to the centerline of the cross-sectional shape. After the point of inflection, a force (F2) tends to “push” all parts of the preform/fiber away from the centerline. This force (F2) creates a final hollow tube and barrier wall 168 shape as shown in FIG. 49C, a cross-sectional view of FIG. 49A. Note that the force (F2) pushes the top of the barrier wall 168 and the sides of the hollow tube outward from the centerline of the cross-sectional shape.

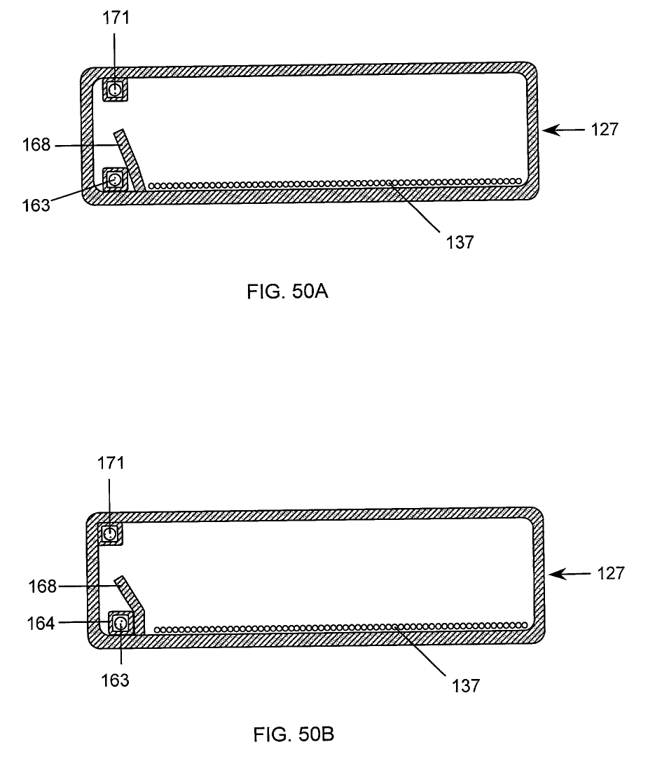

By applying a small negative pressure or vacuum in the centerline of the hollow tube preform 227 during the draw process, the hollow tube 127 is kept from bowing outward, however the barrier wall 168 is still tilted outward, similar to that shown in FIG. 50A. Tilting of the barrier wall 168 during the draw process is advantageous in that it creates a better barrier for the electrophoretic particle 137 flow. Connecting the barrier wall 168 to the small square tube 164, housing the wire drive electrode 163, causes the barrier wall 168 to be bent over top of the wire drive electrode 163 during the draw process, as shown in FIG. 50B.

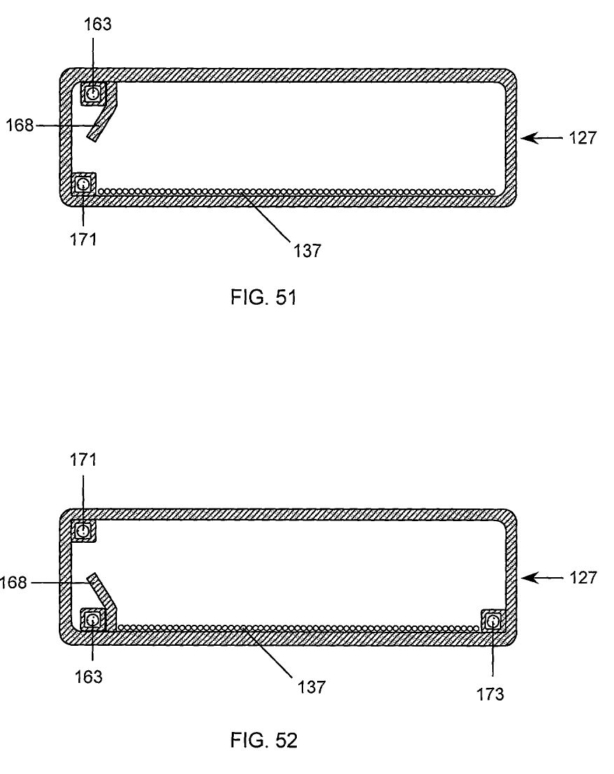

FIG. 51 represents a method of placing the wire drive electrode 163 and barrier wall 168 in the top corner of the hollow tube 127 and the control electrode 171 in the bottom corner of the hollow tube 127. Addressing this type of display could be similar to that discussed above or the top plate 160T with address electrodes 161 (shown in FIG. 38) could be placed below the hollow tubes 127 to replace the bottom plate 160B and planar drive electrode 162. The lines in the display are addressed along the length of the hollow tubes 127 by applying a voltage on the address electrode 161 and modulating the particle flow using the control electrode 171. In addition, the barrier wall 168 is optionally replaced with a barrier electrode, similar to that shown in FIG. 43.

FIG. 52 shows the addition of a second wire drive electrode 173. Adding a second wire drive electrode 173 to the structure of the hollow tube 127 eliminates the need for the planar drive electrode 162 (shown in FIG. 38). Using a second wire drive electrode 173 enhances the addressability of each row of hollow tubes 127 in the display by locally controlling the voltage in each hollow tube 127. Unfortunately, using a second wire drive electrode 173 instead of a planar drive electrode 162 localizes the field and tends to attract the electrophoretic particles 137 toward the second wire drive electrode 162.

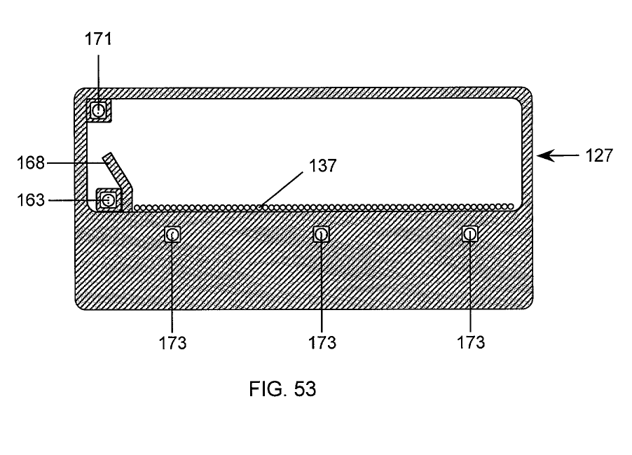

One method to spread out the electrophoretic particles once the cell has been written is to apply a high frequency AC voltage between the two wire drive electrodes 163 and 173. If this high frequency AC voltage is faster than the time it takes the electrophoretic particles 137 to traverse the hollow tubes 127 then it acts as an electronic shaker to spread out the particles. Another method which uses a second wire drive electrode 173 included in the structure of the hollow tubes 127 is to use multiple second wire drive electrodes 173, as shown in FIG. 53. Placing multiple second wire drive electrodes 173 below the center of the hollow tube 127 spreads out the electric field and creates a more uniform attraction potential for the electrophoretic particles 137.

As is obvious from the above examples there are several different methods of using fibers with wire electrodes to form a reflective display. The above figures are only used as an example and are not intended to limit the scope of using wire in fiber for reflective displays.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A reflective display comprising:
a) an electro-optic material that can be electrically addressed;
b) at least one fiber to form structure within said reflective display; and
c) at least one electrode to address said electro-optic material.

2. The reflective display of claim 1, wherein said at least one electrode is located within or on a surface of said at least one fiber.

3. The reflective display of claim 1, wherein at least a portion of a surface of said at least one fiber comprises a channel to support said electro-optic material.

4. The reflective display of claim 1, wherein a plasma is used to assist in addressing said electro-optic material.

5. The reflective display of claim 4, wherein said at least one fiber contains a plasma tube to assist in addressing said electro-optic material.

6. The reflective display of claim 5, further comprising a charging electrode residing in at least one of the following locations:
a) on the inside surface of said plasma tube;
b) within the wall of said plasma tube;
c) on the outside surface of said plasma tube.

7. The reflective display of claim 6, wherein said charging electrode is discontinuous along its length.

8. The reflective display of claim 1, wherein said display also functions in a transmissive mode.

9. The reflective display of claim 1, wherein said electro-optic material is bistable.

10. The reflective display of claim 1, wherein said electro-optic material is comprised of one of the following:
a) a liquid crystal material;
b) comprises an electrophoretic material;
c) an electrochromic material; or
d) a bichromal sphere material.

11. The reflective display of claim 10, comprising rotating a bichromal sphere to a specified angle relative to a field supplied by said at least one electrode.

12. The reflective display of claim 1, wherein said at least one fiber is composed of one of the following:
a) an inorganic material;
b) a polymeric material;
c) a metallic material.

13. The reflective display of claim 1, wherein at least part of said at least one fiber is colored to impart color to said reflective display by at least one of the following:
a) adding the color directly to the composition of said fiber; or
b) adding a color coating to the surface of said fiber.

14. The reflective display of claim 1, wherein said electro-optic material is colored to impart color to said reflective display by at least one of the following:
a) a colored pigment is added to said electro-optic material;
b) a colored liquid is added to said electro-optic material;
c) colored bichromal spheres are added to said electro-optic material.

15. The reflective display of claim 1, wherein a said at least one fiber is absorbing to increase contrast of said reflective display.

16. The reflective display of claim 1, wherein a black matrix material is added to at least part of said at least one fiber by using an absorbing material applied by on of the following:
a) adding the absorbing material directly to the composition of said fiber; or
b) adding an absorbent coating to the surface of said fiber.

17. The reflective display of claim 1, wherein at least a portion of said at least one fiber is composed of a reflective material to assist in the reflectivity of said reflective display.

18. The reflective display of claim 2, wherein at least a portion of a surface of said at least one fiber is contoured to affect an electric field from said at least one wire electrode.

19. The reflective display of claim 2, wherein said wire electrode is composed of one of the following:
a) a metal;
b) a carbon-based material.

20. The reflective display of claim 1, wherein said at least one fiber is curved to fabricate a curved reflective display.

21. The reflective display of claim 1, wherein said at least one fiber contains a conductive material on a surface of said at least one fiber.

22. The reflective display of claim 21, wherein said conductive material is electronically connected to a wire electrode in said at least one fiber.

23. The reflective display of claim 1, wherein at least part of said at least one fiber contains an electrically conductive region.

24. The reflective display of claim 23, wherein said at least one fiber contains a plasma tube with said conductive region where said conductive region electrically connects the inside of said plasma tube to said electro-optic material.

25. The reflective display of claim 23, wherein said conductive region is formed from a mixture of at least one inorganic material consisting of small conductive metal or semiconductor particles mixed in a glass medium.

26. The reflective display of claim 23, wherein said conductive region is formed by ceraming a base glass forming said at least one fiber.

27. The reflective display of claim 26, wherein ceramed region is induced using a laser.

28. The reflective display of claim 23, wherein said conductive region is formed from a conductive glass.

29. The reflective display of claim 23, wherein said conductive region electrically connects a wire imbedded in said at least one fiber to a surface of said at least one fiber.

30. The reflective display of claim 1, wherein said at least one fiber is placed against at least one plate to form said reflective display.

31. The reflective display of claim 30, wherein said at least one said plate contains at least one electrode to assist in addressing said reflective display.

32. The reflective display of claim 30, wherein at least one said plate is composed of one of the following:
a) glass;
b) metal;
c) plastic/polymer.

33. The reflective display of claim 30, wherein a polymer material is placed between said at least one fiber and said at least one plate, said at least one plate located closest to a person viewing said display, to reduce the reflection at that interface.

34. The reflective display of claim 30, wherein a liquid material is placed between said at least one fiber and said at least one plate, said at least one plate located closest to a person viewing said display, to reduce the reflection at that interface.

35. The reflective display of claim 30, wherein a surface of said at least one fiber is curved to create a gap between said fiber and said at least one plate.

36. The reflective display of claim 30, wherein said at least one fiber has legs protruding from at least on surface to create a gap between said fiber and said at least one plate.

37. The reflective display of claim 30, wherein a reservoir is added to said display containing at least part of said liquid.

38. The reflective display of claim 1, wherein said at least one fiber is sandwiched between two plates to form said reflective display.

39. The reflective display of claim 1, wherein said electro-optic material is contained within said at least one fiber.

40. The reflective display of claim 1, wherein a surface of said at least one fiber is curved to alter the reflection of incident light on said display.

41. The reflective display of claim 40, wherein said reflective display is a 3-D display.

42. The reflective display of claim 40, wherein said reflective display is a multiple view display.

43. The reflective display of claim 1, wherein said at least one fiber forms a tube with electrodes at the ends of said tube to ignite a plasma in said tube.

44. A reflective fiber-based display device having a plurality of subpixels, comprising:
a) an electro-optic material;
b) top and bottom fiber arrays that sandwich around said electro-optic material, said top and bottom fiber arrays being substantially orthogonal and defining a structure of said display, said top fiber array disposed on a side facing towards a viewer;
c) a top and bottom plate that sandwich around said top and bottom fiber arrays;
d) wire electrodes within said top fiber array located near a surface of said top fiber array on a side facing away from said viewer such that said wire electrodes within said top fiber array can be used to modulate said electro-optic material;
e) plasma channels within said bottom fiber array such that a plasma can be created within said plasma channels;
f) wire electrodes within said bottom fiber array such that said wire electrodes within said bottom fiber array can be used to address a plasma in said plasma channels such that said plasma in said plasma channels is used to address said electro-optic material; and
g) a drive control system connected to said wire electrodes in said top fiber array and said wire electrodes in said bottom fiber array.

45. A transflective display comprising:
a) an electro-optic material that can be electrically addressed;
b) at least one fiber to form structure within said transfiective display; and
c) at least one electrode to address said electro-optic material.

46. The transflective display of claim 45, wherein said electro-optic material reflects light when addressed.

47. The transflective display of claim 45, wherein said electro-optic material absorbs light when addressed.

48. An electro-optic material created using bichromal spheres inside an oil filled sacs.

49. An electro-optic material of claim 48, wherein said bichromal spheres inside an oil filled sacs are mixed with a clear polymer film that is impermeable to said oil and a sheet is formed from said mixture.

50. A electronic drive control system containing a sequentially addressing drive mechanism consisting of a high voltage waveform source connected to a wiper blade that is either rotated or translated to contact to and address at least 16 lines in a display.

51. A method of fabricating hollow tubes for an electronic display comprising the step of drawing at least one hollow tube from a larger preform, wherein a partial vacuum is applied to the centerline of the preform to maintain a cross-sectional shape of the preform.

52. A method of redistributing electrophoretic particles in an electronic display comprising the step of applying an AC voltage to an electrode within said display.
